(19) United States
(12) Patent Application Publication
(10) Pub. No.: US 2005/0019372 A1
(43) Pub. Date: Jan. 27, 2005

(54) Modified-fat nutritional products useful preventing or treating obesity

(75) Inventors: Barbara E. Corkey, Boston, MA (US); Wen Guo, Stoneham, MA (US); Han Jianrong, Stoneham, MA (US)

Correspondence Address: LAHIVE & COCKFIELD, LLP., 28 STATE STREET, BOSTON, MA, 02109, US

(73) Assignee: Barbara E Corkey

(21) Appl. No.: 10/483,350

(22) PCT Filed: Jul. 10, 2002
(86) PCT No.: PCT/US02/21908

Related U.S. Application Data
(60) Provisional application No. 60/304,476, filed on Jul. 10, 2001.
(60) Provisional application No. 60/327,635, filed on Oct. 7, 2001.

(51) Int. Cl. A61K 47/00

(52) U.S. Cl. 424/439

(57) ABSTRACT

The present invention provides dietary products for infant child and adult nutrition which possess adequate levels and ratios of medium chain fatty acids and ω-polyunsaturated fatty acids. Consumption of these dietary products can contribute to the prevention of obesity in developing individuals and can contribute to a reduction in body fat mass in individuals who are trying to loose weight or reduce body fat mass (e.g., obese individuals). A first preferred product is a dairy supplement or formulated dairy product for consumption by infants or children to prevent development of obesity. A second preferred product is a dietary suppplement for persons combating unwanted weight gain or obesity. Also featured are methods of formulating these dietary products.

### RELATED APPLICATIONS

This application claims priority to U.S. provisional Application Ser. No. 60/304,476 filed on Jul. 10, 2001, and to U.S. provisional Application Ser. No. 60/327,635 filed Oct. 7, 2001, the entire contents of each of which are incorporated herein by this reference.

### GOVERNMENT INTEREST

This work was supported by grants AHA/GIA 13519967, AG/DK 13925, HL 26335, and DK 46200. The government may have rights in this invention.

### BACKGROUND

Milk is the sole food for human and all mammals in the first part of life. Up to 50 years ago, milk was also considered an important part of the adult diet. In the 1950s, a new hypothesis that suggested that serum cholesterol and dietary fat were the risk factors for heart disease was proposed (Keys, 1953). This largely damaged the image of milk fat because of its cholesterol and fat content, led to decreased per capita consumption of milk, and promoted the production of fat-free/low fat milk products. Promoters of competing products have also exploited this situation such that a variety of non/low-fat drinks replaced milk even in the diet of young children. However, recent studies showed that consumption of milk fat has little effect on serum cholesterol (Blaxter, 1991).

Many believe that milk fat consumption may result in increased body fat mass development. This may not be correct. In fact, coincident with the decrease in milk consumption, a large increase in adult and childhood obesity has been observed in the past several decades. Restriction of animal fat intake (milk) in children <6 y of age was found to cause early stunting but increased adult obesity (Uauy, 2000). Animal studies also showed that rats that drink whole milk gain less weight and store less liver triglycerides compared to rats that drink water (Krutchevsky, 1979). Similarly, milk consumption also lowered plasma triglycerides in young men (Rossouw, 1981) and rats (Schneeman, 1989).

Milk fat contains a significant fraction of short to medium chain (4-10 carbons) fatty acids (Bitman, 1996) (Palmquist, 2001), which are not found in other foods except coconut or palm oil. Increased carbohydrate intake increases the percentage of medium chain fatty acids (MCFA) in milk triglycerides (Beusekom, 1990). These MCFA are not associated with the risk of CHD (Hu, 1999), and might have unique positive effects on health (Roediger, 1986). A recent study shows that compared to bovine milk, pigs fed caprine milk have similar growth performance but acquired 43% less fat mass (Murry, 1999). This was largely attributed to the higher concentration of MCFA in caprine milk (35%) (Murry, 1999) than bovine milk (17-29%) (Murry, 1999) (Bitman, 1996).

### SUMMARY OF THE INVENTION

The present invention features dietary supplements and products aimed at preventing obesity, reducing fat mass, and/or reducing serum TGs (in particular, serum TGs associated with traditional MCT diets). In one embodiment, the invention features a milkfat-derived MCT-rich component that contains an appropriate ratio of milkfat-derived MCFAs to milkfat-derived LCFAs (e.g., between 5:1 to 10:1) and a sufficient amount of −3 PUFAs (e.g., between 1% and 5%). In another embodiment, the invention features a dairy product for human consumption comprising the milkfat-derived MCT-rich component of the present invention, preferably a milk for human consumption comprising the milkfat-derived MCT-rich component of the present invention. In yet another embodiment, the invention features a dietary supplement that includes an appropriate ratio of MCFAs to LCFAs, a sufficient amount of −3 PUFAs and a protein source (e.g., a soy protein source). In a preferred embodiment, the dietary supplement does not include a carbohydrate source.

### BRIEF DESCRIPTION OF THE DRAWINGS

FIG. 1 ¹³C-NMR spectra of lipid extracts after cells were incubated with [1-¹³C]fatty acids. (A) Oleate and (B) octanoate in 3T3-L1 fat cells, and (C) octanoate in HepG2 cells. Above the spectra is shown a molecular formula of palmitoleate, a common end product of de novo synthesis of LCFA. The spectrum was obtained with 2000 (A) and 4000 (B and C) scans.

FIG. 2 Bar graph depicting incorporation of fatty acide into cellular TG. (A) Incorporation of [1-¹³C]fatty acids into cellular TG as a function of chain length; (B) Quantitation of total cellular TG.

FIG. 3 Time-dependent incorporation of fatty acids into cellular TG. (A) Incorporation of [1-¹³C]oleate and [1-¹³C]octanoate into cellular TG as a function of incubation time; (B) Lipolysis determined in adipocytes treated with or without octanoate; Inducers of lipolysis include isoproterenol (Iso), norepinephrine (NE) and forskolin; (C) Northern blot depicting hormone-sensitive lipase (HSL) down-regulation by octanoate; (D) The acyl chain-specific esterification of [1-¹³C]oleate and [1-13C]octanoate, as determined by the relative-peak-intensity ratio of the TG(1,3)/TG(2).

FIG. 4 Micrographs (magnification ×200) of 3T3-L1 cells after incubation for 9 days with basal medium containing insulin (2.5 μg/ml) in the presence of 1 mM octanoate (A) and oleate; (B) in 0.2 nM BSA. These cells were not treated with methylisobutylxanthine or dexamethasone.

FIG. 5 Graphic depiction of the effects of octanoate on oleate storage and glucose conversion to the glycerol backbone in TG. (A) Incorporation of [I-¹⁴C]oleate into cellular TG as a function of increasing octanoate concentration; (B) [1-¹⁴C]glucose conversion to the glycerol backbone in TG in fat cells treated with octanoate, oleate or octanoate plus oleate.

FIG. 6 Micrographs of 3T3-L1 cells treated with hormonal inducers of differentiation in the presence of variable octanoate and oleate. (A) Control cells; (B) Cells incubated with 100 μM oleate; (C) Cells incubated with 100μM oleate and 1 mM octanoate; (D) Cells incubated with 1 mM octanoate. Cells were stained for lipids by oil-red-O.

FIG. 7 Octanoate-induced inhibition of two master regualtors of fatty acid homeostasis. (A) Northern blot analysis of peroxisome proliferation activator receptor γ (PPARγ) and CCAAT enhancer binding protein α (C/EBPα) mRNAs as a function of octanoate concentration; (B) Western blot analysis of peroxisome proliferation activator receptor γ (PPARγ), (ADD1)/sterol regulatory element binding protein-1c (SREBP-1c), CCAAT enhancer binding protein a (C/EBPα), and adipocyte lipid-binding protein (ALBP/aP2) as a function of octanoate concentration.

FIG. 8 Octanoate-induced down-regulation of two master regualtors of fatty acid homeostasis and lipogenesis in mature adipocytes. (A) Western blot analysis of peroxisome proliferation activator receptor γ (PPARγ) and CCAAT enhancer binding protein a (C/EBPα) in the presence and absence of octanoate; (B) [1-¹⁴C]precursor incorporation into TG in mature cells treated with or without octanoate.

FIG. 9 Quantitative incorporation of [1-¹³C]octanoate into sn-1,3 [TG1,3)], Sn-2 [(TG(2)] and total TG [TG(1,2,3)] as a function of cellular G3PD activity. Inset: TG(1,3)/TG(2) ratio as a function of G3PD activity.

FIG. 10 The total cellular TG before and after lipolysis (A) and the amount of glycerol released during the incubation; (B) Cells were pre-treated with oleate or octanoate as indicated. The data points are connected by lines purely for visual examination of the results.

FIG. 11 ¹³C-NMR spectra (carbonyl region) of cellular lipids before (left) and after (right) 96 h of basal lipolysis of cells pre-treated with [1-¹³C]oleate (A, B) and [1-¹³C]octanoate (C, D).

FIG. 12 Effects of feeding MCT oil versus corn oil, each with or without fish oil. FIG. 12A indicates food intake, body weight gain and plasma triglycerides for animals fed each regimen. FIG. 12B indicates food intake and plasma leptin levels for animals fed each regimen.

FIG. 13 Effects of MCFA on lipogenesis, lipid storage and lipid secretion from liver cells in te presence and absence of DHA. (A) Cellular T-G measured in HepG2 cells (human hepatoma cells) treated with 180 uM oleate or 380 uM octanoate, plus 20 UM-DHA. (B) incorporation of [1,2-¹⁴C] acetate into cellular lipids in HepG2 cells exposed to MCFA with or without 5% DHA; (C) incorporation of [1,2-¹⁴C] acetate into secreted lipids in HepG2 cells exposed to MCFA with or without 5% DHA.

FIG. 14 The fatty acid composition of TG isolated from rat epididymal preadipocytes differentiated in enriched medium containing insulin and TPN with additional oleate (1 mM) or octanoate (1 mM) for 24 hr. The fatty acids were delivered in 0.2 mM BSA solution.

FIG. 15 Fatty acid composition in the plasma membrane phospholipids isolated from cells incubated with oleate/linoleate with or without octanoate (left) and the subsequent changes in saturated, monounsaturated, and polyunsaturated FFA as a result of adding a moderate amount of octanoate (right).

FIG. 16 demonstrates effects of feeding MCT diet on animal growth, food intake, plasma leptin levels and fat mass.

FIG. 17 demonstrates that body weight gain effects in MCT fed animals are consistent.

FIG. 18 demonstrates that MCT oil enriched diets redice body fat mass without affecting lean mass or bone density.

### DETAILED DESCRIPTION OF THE INVENTION

The present inventors have discovered that MCFA can regulate both triglyceride storage and differentiation of fat cells. In particular, octanoate is more oxidized than stored by fat cells, in contrast to oleate which is more stored. The accumulation of oleate into fat cell TGs increases with both time and concentration of exogenously added oleate, whereas octanoate incorporation becomes saturated and accounts for only about 10% of total fatty acids stored. Fat cells pretreated with octanoate had a significantly enhanced rate of TG hydrolysis. Moreover, octanoate but not oleate, prevents the differentaition of fat cells.

Understanding the mechanisms by which MCFA regulate metabolism of fat cells has allowed the present inventors to formulate dietary supplements and products aimed at reducing fat mass during development. This reduced fat mass will result in subjects being less sensitive to diet induced obesity later in life.

In particular, the invention features a modified milk product having a higher MCT concentration and, optionally, a lower LCT concentration than whole milk. In one embodiment, the invention features a modified dietary fat derived from milk which can be used to supplement low-fat or reduced-fat milk products. The modified dietary fat comprises MCT concentrated from milkfat which can be used as a dietary fat to replace at least part of the LCT in milk. It is predicted that when fed at a young age, this milkfat-derived MCT-rich component will negatively affect fat mass development at a young age and reduce the incidence of obesity at both young and adult ages.

Preliminary data have been obtained in animals fed MCT oil derived from coconut oil and in adipocytes treated with MCFA in vitro. Milkfat derived MCT is predicted to have similar or better effects because milkfat also contains other fatty acids such as conjugated linoleic acids (CLA) that have similar water solubility as MCT and thus are likely to be recovered together with the MCT fraction during the separation process. The ability of CLA to inhibit fat mass development has been described (Brodie, 1999).

A primary objective of the present invention is to provide a fat mixture which contains adequate ratios of MCFAs to LCFAs, the ratio preferably being between 5:1 to 10:1. In a preferred embodiment, the fat mixture contains a sufficient amount of PUFAs, preferably about 1-10% (e.g., 1-5%, 5-10%), more preferably about 5%. The fat mixture can also preferably also contain adequate ratios of the long chain PUFAs of the ω-3 and ω-6 series, the ratio preferably being between 2:1 to 5:1 or 10:1. These controlled amounts and ratios are desirable to prevent and treat obesity in developing children and adults.

Another objective is to provide a nutritional product, in particular a dairy product (e.g., a milk product) containing adequate ratios of MCFAs to LCFAs and preferably containing a sufficient amount of PUFAs. The specific features of this product include: (a) a high ratio of MCFAs to LCFAs; and (b) adequate or sufficient omega-3 fatty acids.

Another objective is to provide a nutritional supplement containing an apropriate amount and ratio of MCFAs to LCFAs, a sufficient amount of PUFAs, and a protein source, preferably a soy protein source. Dietary formulations on the market featuring MCT oils, both for adult and infant nutrition, are usually characterized by inclusion of carbohydrates as a primary source of calories. The formulations of the instant invention feature, for example, protein and oils as the sole source of calories and are aimed at stimulating fatty acid metabolism, fat mass breakdown, TG hydrolysis, and the like. A preferred product features : (a) a high MCFA/LCFA ratio; (b) 1-5% ω-3 PUFA; and (c) 5-50%, preferably, 20-40%, more preferably 35% protein (e.g., soy protein).

Glyceirides, Triglycerides, Fats and Oils

A glyceride is an ester of glycerol (1,2,3-propanetriol) with acyl radicals of fatty acids and is also known as an acylglycerol. If only one position of the glycerol molecule is esterified with a fatty acid, a “monoglyceride” is produced; if two positions are esterified, a “diglyceride” is produced; and if all three positions of the glycerol are esterified with fatty acid a “triglyceride” or “triacylglycerol” is produced. A glyceride is called “simple” if all esterified positions contain the same fatty acid; or “mixed” if different fatty acids are involved. The carbons of the glycerol backbone are designated sn-1, sn-2 and sn-3, with sn-2 being in the middle and sn-1 and sn-3 being the ends of the glycerol.

Naturally occurring oils and fats consist largely of triglycerides wherein the 3 fatty acyl residues may or may not be identical. The term “long chain triglycerides (LCT)” means both a simple and mixed triglyceride containing fatty acids with more than 12 carbon atoms (long chain fatty acids—“LCFA”), whereas the term “medium chain triglycerides (MCT)” means both a simple and mixed triglyceride containing fatty acids with 4 to 12 carbon atoms. Naturally occurring oils are frequently “mixed” with respect to specific fatty acids, but tend not to contain LCFAs and MCFAs on the same glycerol backbone. Thus, MCT oils or fats contain predominately medium chain fatty acids; whereas LCT fats contain predominantly long chain fatty acids.

Many of the properties of oils and fats can be accounted for directly in terms of their component fatty acids. The fatty acids in naturaly-occurring foodstuffs usually contain an even number of carbon atoms in an unbranched chain, e.g., lauric or dodecanoic acid. Besides the saturated fatty acids, of which lauric acid is an example, fatty acids may have 1, 2 or sometimes up to 6 double bonds and are, therefore, unsaturated. The number and position of double bonds in fatty acids are designated by a convention of nomenclature typically understood by the organic chemist. For example, arachidonic acid (“AA” or “ARA”) has a chain length of 20 carbons and 4 double bonds beginning at the sixth carbon from the methyl end. As a result, it is referred to as “20:4 n-6”. Similarly, docosahexaenoic acid (“DHA”) has a chain length of 22 carbons with 6 double bonds beginning with the third carbon from the methyl end and is thus designated “22:6 n-3”.

In native fats and oils, the various fatty acids are esterified through one of the three hydroxy groups of the glycerol molecule in an ordered pattern that is characteristic of the particular fat or oil. In general, the naturally occurring, long chain, saturated fatty acids (e.g., C.sub.16-C.sub.18) are predominantly at the sn-1 and sn-3 positions, while the mono- and polyunsaturated fatty acids are at the sn-2 or middle position of the triglyceride molecule. There are only a small number of naturally-occurring “simple triglycerides ”, for example, tripalmitin (C.sub.16), triolein (C.sub.18) and the like.

Medium Chain Triglycerides (MCTs)

Medium chain triglycerides, generally obtained from kernel oils or nut fats (e.g., coconut fats) and encompassing those substituted with C₆ to C₁₂, predominantly C₈ to C₁₀, fatty acids, have been of particular interest because they are more rapidly absorbed and metabolized, via a different catabolic route than those bearing long chain fatty acids. Hence, medium chain triglycerides have been employed in premature infant formulas and in the treatment of several malabsorption syndromes. Current knowledge on the application of MCT for obesity control is controversial, mostly because that the hepatic de novo synthesis and secretion of long chain lipids have not been resolved.

Coconut oil, macadamia oil, palm oil, palm kernel oil, or mixtures thereof, are all examples of medium-chain triglycerides. MCT oils are obtained by the hydrolysis of coconut and palm kernel oils and the distillation of the fatty acids.The oils can be used in their natural states; alternatively, structured triglycerides, which can be either randomly re-esterified or specifically reesterified, can be generated from two or more oils and used as a fat source.

Polyunsaturated Fatty Acids (PUFAs)

Long chain PUFAs are those which contain more than 18 carbon atoms and are synthesized from the precursor polyunsaturated fatter acids via a successive desaturation and elongation process. Each of these families includes fatty acids with similar chain lengths and unsaturation levels. However, none of the members of one family are exactly the same as the corresponding members of the other family. Moreover, the families of polyunsaturated fatty acids are unique. They are metabolically derived from different precursors and can not be interconverted. In addition, each type of fatty acid has a different function in the human body and they are not interchangeable.

The ω-3 (or n3) series of polyunsaturated fatty acids, which is now considered essential during early postnatal life in human beings, is derived from α-linolenic acid, C18:3n3. The ω-6 (or n6) series, which is considered essential to human life, consists of fatty acids which are derived from linoleic acid, C18:2n2. The ω-9 (or n9) family of fatty acids is derived from oleic acid, C18:1n9, and the ω-7 (or n7) series is derived from palmitoleic acid, C16:1n7. These two families can be synthesized endogenously.

There is a standard nomenclature for referring to polyunsaturated fatty acids by the chain length, the number of unsaturations and the family to which the fatty acid belongs. For example, the notation (18:2n6) represents linoleic acid. The first number is the length of the carbon backbone. The second number is the number of double bonds present in the fatty acid and the final letter/number designation discloses the family to which a particular fatty acid belongs. Other representations of common fatty acids using this nomenclature are ω-linolenic acid (18:3n3) and oleic acid (18:1n9).

Milk Fats

Human milk contains about 4 g/dl of lipids made up of the following components: 98% are triglycerides, 0.8% are phospholipids and 0.3% are cholesterol. Human milk generally contains the following amounts and types of fatty acids. The oleic acid (18:1n9) content of human milk ranges between 30-40%. Palmitic acid (16:0) is present from 20 to 25%. Stearic acid (18:0) makes up 5 to 7% of the fatty acids and myristic acid makes up about 4-7% of the fatty acids. The linofeic acid content normally varies between 6-16% and α-linolenic acid content varies between 1.2-1.3% of total fatty acid content.

The average composition of the fatty acids in human milk is shown in Table 1.

TABLE 1
Fatty Acid Composition of Human Milk

| Fatty Acid | Mean Amounts +/− SEM* | |
|---|---|---|
| 10:0 | 1.78 +/− 0.16 | |
| 12:0 | 7.15 +/− 0.36 | |
| 14:0 | 6.48 +/− 0.31 | |
| 15:0 | — | |
| 16:0 | 16.96 +/− 0.31 | |
| 16:1n7 | 3.21 +/− 0.12 | |
| 17:0 | — | |
| 18:0 | 4.80 +/− 0.16 | |
| 18:1n9 | 40.14 +/− 0.90 | 30-45% |
| oleic | | |
| 18:2n6 | 16.07 +/− 0.71 | 6-20% |
| (linoleic) | | |
| 18:3n3 | 1.36 +/− 0.10 | 0.3-1.8% |
| (α-linolenic) | | |
| 20:0 | — | |
| 20:2n6 | 0.50 +/− 0.71 | |
| 20:3n6 | 0.68 +/− 0.71 | |
| 20:4n6 | 0.66 +/− 0.71 | 0.1-1% |
| (arachidonic acid) | | |
| 20:5n3 | 0.21 +/− 0.10 | |
| (eicosapentaenoic acid, EPA) | | |
| 21:0 | — | |
| 22:4n6 | 0.1 +/− 0.10 | |
| 22:5n6 | — | |
| 22:5n3 | 0.25 +/− 0.10 | |
| 22:6n3 | 0.40 +/− 0.10 | 0.1-1 |
| (docosahexaenoic acid, DHA) | | |

*SEM = Means Standard Error

Human milk contains both medium chain, a well as long chain fatty acids, and is especially rich in PUFA of the n6 and n3 series. The total amount of these acids is normally about 2% of the total amount of fatty acids present in human milk. Of these long chain acids, arachidonic acid (20:4n6), docosahexaenoic acid (22:6n3) and eicosatrienoic acid (20:3n6) are the predominant long chain PUFAs. Human milk fatty acid composition varies with dietary intake. For example, a high carbohydrate diet leads to increased MCFAs in the milk (Beusekom, 2001).

General Definitions

The terms “wt. %” or “weight percent” means the ratio of the mass of the recited component to the mass of the specified ingredient or entire composition multiplied by 100. For example, “a triglyceride comprising 40 wt. % acyl moieties of 10 carbon atoms” means that 100 gms of the triglyceride oil consists of 40 gms of 10 carbon atoms acyl radicals and 60 gms of other components, including other acyl radicals and the glycerol backbone.

The term “fish oil” means the oil derived from fish sources, such as menhaden, sardine, cod and the like. Fish oil has gained much attention in recent years as Eskimos, who consume high levels of fish oils, have a remarkably low incidence of arterial disease. Fish oils are rich in polyunsaturated long chain fatty acids such as eicosapentaenoic acid (20:5n-3) and docosahexaenoic acid (22:6n-3).

The phrase “adequate” ratio, e.g., an adequate ratio of MCFAs to LCFAs, is a ratio that facilitates reduced triglyceride storage in peripheral cells (in particular, fat cells) and/or reduced adipogenic differentiation and/or reduced fat mass in a subject. The phrase “sufficient” amount of PUFAs, e.g., a sufficient amount of −3 PUFAs, is an amount that detectably reduced serum triglycerides as compared, for example, to serum triglyceride levels in a subject supplementing their diet with MCTs or MCFAs or consuming products having high MCFA:LCFA ratios.

Formulations and Processes

Dietary Supplements

The dietary supplements of the invention can be made by blending the oils (fatty acid sources), proteins, and any additional additives, and homogenizing the mixture into a stable emulsion. In one embodiment, the supplement is made by (a) preparing individula slurries/solutions which are then combined together; (b) adding vitamins, minerals and flavorings; and (c) packaging and/or sterilizing the resultant product.

An oil blend can be prepared, for example, by the following procedure. The medium chain triglycerides (and, where appropriate, soybean oil) are placed in a vessel and while being continuously agitated are heated to a temperature appropriate to allow the oils to blend. An emulsifier can be added to the resultant oil blend and allowed to dissolve therein before adding the remaining ingredients. Examples of suitable emulsifiers include, but are not limited to, lecithin (e.g., from egg or soy), and/or mono- and di-glycerides. Other emulsifiers are readily apparent to the skilled artisan and selection of suitable emulsifier(s) will depend, in part, upon the formulation and final product. Oil soluble vitamins (premixed), can then be added to the oil blend. Next, stabilizers can be added to the oil blend and the blend cooled to between about 43-49° C. Fish oil is added, if appropriate, at this point and the mixture agitated until the ingredients are thoroughly combined. Exemplary fish oils are tuna-derived oils or sardine-derived oils.

Protein sources can be added as a protein-in-water slurry, preferably by heating and agitating the protein source in water at a temperature in the range of about 54-60° C. The resultant slurry can be, for example, between 5-25% or 10-15% total solids. The oil blend and protein-in-water slurries are then combined together. The resultant final blend can then be heat processed using art recognized procedures featuring, for example, heating and/or cooling, de-aerating, emulsification, homogenization and the like.

The protein can include one or more sources of protein, including a purified protein, protein powder or protein isolate. As used herein, the term “protein hydrolysate” refers to a peptide preparation which contains less than about 10% free amino acids, more preferably less than about 5% free amino acids, and consists substantially of peptides that are less than 40 amino acids in length with more than 50% of the peptides having molecular weight of less than 5,000 kDa, more preferably with about 90-95% of the peptides having molecular weight of less than 5,000 kDa.

The protein hydrolysate may be any suitable partially hydrolyzed protein or protein hydrolysate utilized in a nutritional formula such as soy protein hydrolysate, casein hydrolysate, whey protein hydrolysate, animal and vegetable protein hydrolysates, partially hydrolyzed whey, casein or soy proteins, and mixtures thereof. Soy or casein protein hydrolysates comprising a substantial proportion of variable chain length peptides, e.g., medium chain and short chain peptides, e.g., di- and tri-peptides, but having less than about 10% free amino acids, preferably less than about 5% free amino acids, are preferred.

Other sources of protein can include whey protein, whey protein concentrate, whey powder, egg, soy protein, soy protein isolate, caseinate (e.g., sodium caseinate, sodium calcium caseinate, calcium caseinate, potassium caseinate), animal and vegetable protein and mixtures thereof. In a preferred embodiment, the protein source is soy protein, soy protein isolate or soy protein hydrolysate. A manufacturing process for the production of soy protein hydrolysate is taught in U.S. Pat. No. 4,100,024

The dietary supplements can also include other ingredients such as preservatives or antioxidants. Exemplary preservatives include potassium sorbate, sodium sorbate, potassium benzoate, sodium benzoate or calcium disodium EDTA. The supplements may also contain a stabilizer such as λ-carrageenan or xanthan gum. Trace mineral solutions or water-soluble vitamin solutions (e.g., about 20% weight-to-volume) can be added to the final blend. Vitamins and/or minerals that can be added include, but are not limited to, calcium phosphate or acetate, tribasic; potassium phosphate, dibasic; magnesium sulfate or oxide; salt (sodium chloride); potassium chloride or acetate; ascorbic acid; ferric orthophosphate; niacinamide; zinc sulfate or oxide; calcium pantothenate; copper gluconate; riboflavin; beta-carotene; pyridoxine hydrochloride; thiamin mononitrate; folic acid; biotin; chromium chloride or picolonate; potassium iodide; sodium selenate; sodium molybdate; phylloquinone; Vitamin D₃; cyanocobalamin; sodium selenite; copper sulfate; Vitamin A; Vitamin E; Vitamin B₆ and hydrochloride thereof; Vitamin C; inositol; Vitamin B₁₂; and/or potassium iodide.

Selection of one or several of these ingredients is a matter of formulation design, consumer preference and end-user. The amount of these ingredients added to the nutritional supplements of this invention are readily known to the skilled artisan and guidance to such amounts can be provided by the U.S. RDA doses for infants, children and adults. Herbs, such as ginkgo biloba or ginsing may also be added to the supplements.

Flavorings, for example, fruit extracts, nut extracts, mint extracts, and the like are preferably not added if containing sugars, as the weight loss supplements are preferably prepared without carbohydrates. Flavorings may be added if providing only minimal caloric source. Alternatively, artificial sweeteners, e.g., saccharides, cyclamates, aspartamine, aspartame, acesulfame K, sorbitol, and the like, can be added to flavor the weight loss supplements.

The final blend can be packaged in liquid form, added directly to, for example, dairy products, formulated into capsules, and the like, and optionally sterilized.

It is desirable to administer the dietary supplement as part of the subject's regular diet. Alternatively, the supplements can be administered to persons on calorie-restricte diets, carbohydrate-restricted diets, and the like.

The following Examples are intended to illustrate the present invention, and in no way are intended to the limit the invention.

### EXAMPLES

The following Examples demonstrate, in addition to being directly metabolized by liver cells, have metabolic effects on peripheral cells, in particular, fat cells. The Examples demonstrate that MCFA are capable of effecting TG storage, TG esterification, lipolysis, and fat cell differentiation. Moreover, controlling the ratio of MCFAs to LCFAS and incorporating a sufficient amount of PUFAs into preferred fat mixtures can effect not only fat storage but levels of circulating TGs as well. Based on these heretofor unrecognized metabolic effects of MCFA, dietary formulations are taught that can be used to supplement the diets of persons having normal fat stores or excess fat stores, to prevent fat cell differentiation and/or lipid accumulation.

Introduction

Because MCFA can be activated within mitochondria for β-oxidation independent of CPT-I control, it is generally believed that MCFA are rapidly oxidized without sustained metabolic effects. It has been demonstrated that medium-chain fatty acids (MCFA) are more efficiently oxidized than long-chain fatty acids (LCFA) at the whole-body level [1,2] and in isolated tissue or cells [3-7]. However, little is known about how MCFA are metabolized via pathways alternative to oxidation, and how this affects other metabolic events in cells.

Medium-chain triacylglycerols (MCT) have been used as nutrients for patients with disorders of long-chain triacylglycerol (LCT) or glucose metabolism for decades. Several early studies demonstrated that MCT diets prevented weight gain in animals [8-10] without affecting plasma cholesterol or other physiological parameters [11,12]. Feeding MCT early in life influenced adipose-tissue development and resulted in fewer and smaller fat cells with less lipid [10]. Neurotoxicity [13] and ketosis [14] have only been reported after acute, high-dose MCT intravenous infusion in animals. Recent trials have demonstrated that the addition of MCT to human diets is of benefit for certain dyslipidaemic disorders including diabetes [15,16]. The rationale for these therapeutic benefits is not fully understood. The potential applications of MCT in the treatment of obesity have been reviewed in [17,18].

While it is generally accepted that MCFA are absorbed via the portal vein and are oxidized in the liver, a recent study shows that when fed enterally to rats, significant amounts of MCFA relative to LCFA appear in lymph [19]. Chylomicron triacylglycerols (TG) in human subjects consuming MCT diets also contained significant amounts of MCFA [20]. Infants fed MCT-enriched formulae accumulated substantial amounts of MCFA in their adipose tissues [21]. We also found that adipose tissues from young (2-week-old) rats contain levels of MCFA that are more than 2-fold higher than those in older ones (3-months old; W. Guo and B. E. Corkey, unpublished work). This is most probably due to storage of MCFA acquired from milk in the young rats and their loss after weaning. In pre-term infants, about 27% [22] to 50% [23] of the dietary MCT intake was oxidized. On the other hand, up to 82% and 90% of octanoate was recovered as CO2 in fed and fasted rats after 6 h of intravenous infusion of octanoic acid [24]. These studies indicate that MCT may not be exclusively oxidized in the liver, especially after an extended feeding period. Accordingly, there exists the need to more fully understand the mechanisms by which MCFA which are not oxidized by the liver can effect metabolism in peripheral tissues.

Material and Methods

Chemicals. 1-¹³C-Labelled free fatty acids (FFA) and deuterated solvent (chloroform) were purchased from Cambridge Isotope (Cambridge, Mass., U.S.A.). Other organic solvents were of HPLC grade from Aldrich (Milwaukee, Wis., U.S.A.). [I-¹³C]Methyl palmitate was synthesized as described previously [25]. Cell-culture medium, fetal bovine serum, penicillin and streptomycin were purchased from Gibco (Grand Island, N.Y., U.S.A.). Methylisobutylxanthine, dexamethasone and insulin were purchased from Sigma (St. Louis, Mo., U.S.A.).

Cell Culture. NIH-3T3-L1 cells were cultured in basal medium [Dulbecco's modified Eagle's medium (DMEM), fetal bovine serum (10%), penicillin (100 units/ml) and streptomycin (100 μg/ml)] until 2 days post-confluence. To induce differentiation, unless otherwise indicated, cells were exposed to basal medium supplemented with MDI [methylisobutylxanthine (120 μg/ml), dexamethasone (0.39 μg/ml) and insulin (10 μg/ml)]. Cells were washed 2 days later and then exposed to insulin (2.5 μg/ml)-supplemented basal medium. Medium was changed every 2 days. Lipid droplets were visible by phase-contrast microscopy 2 days after MDI treatment. HepG2 cells were grown in DMEM with 10% fetal bovine serum containing the same concentrations of the above antibiotics and were used 2 days post-confluence.

Fatty acid induced differentiation. Cells were exposed to oleate or octanoate (1 mM in 0.2 mM BSA) and insulin (2.5 μg/ml) in basal medium 2 days after they had reached confluence. The 5:1 molar ratio of FFA/BSA promotes net transfer of FFA from BSA-binding sites to cells [26]. No MDI treatment was applied to these cultures.

Incubation with [1-¹³C]FFA. A stock solution containing [1-¹³C]octanoate or [1-¹³C]oleate (1 mM in 0.2 mM BSA) was added to the cell culture during a regular medium change. At termination, cells were washed three times with an ice-cold solution (pH 7.4) containing sucrose (250 mM), Tris (10 mM) and 2-mercaptoethanol (1 mM), scraped into the above solution containing additional EDTA (0.2 mM) and homogenized. Aliquots of the homogenate were stored at −80° C. for DNA and TG analysis. Aliquots for glycerol-3-phosphate dehydrogenase (G3PD) analysis were centrifuged at 44000 g for 20 min and the supernatants were stored at −80° C. until analysis. The homogenates were then extracted for lipids for NMR studies as described previously [25,27].

Partitioning of [1-¹⁴C]FFA between CO₂production7 and TG incorporation. 3T3-L1 cells were prepared in T25 culture flasks. After MDI treatment (4 days), cells were exposed to basal medium containing insulin (2.5 μg/ml) and 1 mM fatty acids (in 0.2 mM BSA) as described above but with a trace amount of [1-¹⁴C]octanoate or [1-¹⁴C]oleate (3 μCi). The incubation was terminated after 60 min. ¹⁴CO₂ released from fatty acid oxidation was collected and quantified using a published protocol [4]. The cellular lipids were extracted and separated by TLC. The TG fraction was scraped off and dissolved in Ecosin-A solution for scintillation counting. The d.p.m. values of the reaction products (CO₂, TG) were converted into nmol by referring to the d.p.m. values of known concentrations of the starting materials ([1-¹⁴C]octanoate and [1-¹⁴C]oleate). Cellular DNA was measured in parallel cultures.

Measurement of basal lipolysis. After the MDI treatment (4 days), cells were incubated with [1-¹³C]octanoate or [1-¹³C]oleate for 16 h so that the intracellular TG pool was enriched with the corresponding isotope-labelled fatty acids. Control cultures were terminated at this time, and cells were homogenated for TG and DNA analysis. After aliquots were taken for these analyses, cellular lipids were extracted for NMR and GLC analysis. Parallel cultures were washed three times with PBS solution and incubated with serum-free DMEM containing 1% BSA, conditions that favour basal lipolysis. At the end of the incubation, media were aspirated and assayed for glycerol (Sigma procedure no. 337A [27]), and the cells were harvested for analysis as described above. The cell morphology examined before and after the incubation showed that more and/or larger lipid droplets appeared after 96 h of incubation. However, there was no microscopically detectable difference between the cells pre-treated with oleate or octanoate.

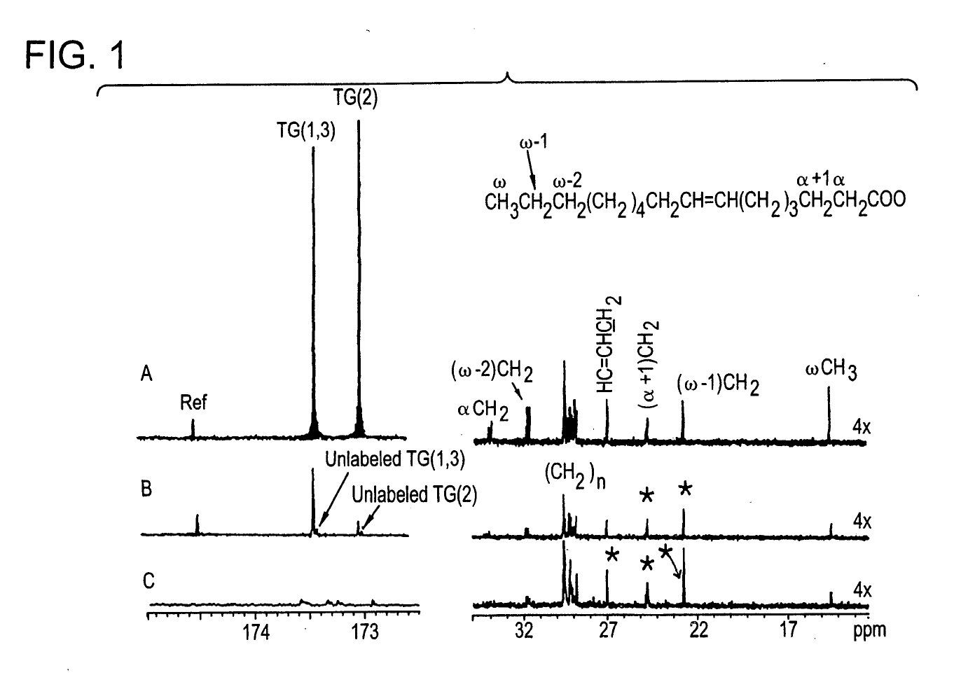

Quantification of ¹³C label incorporation into cellular TG from the NMR peak intensity. The ¹³C-NMR spectra were obtained at 125 MHz on a Bruker DMX-500 spectrometer with a 5-mm triple resonance probe (Bilerica, Mass., U.S.A.). Other details have been described in our previous reports [25,27]. The absolute intensities of ¹³C═O signals were measured by reference to an internal standard [25]. For cells incubated with [1-¹³C]oleate, the ¹³C═O signals from direct incorporation were very intense compared with those from unlabelled carbons (>90-fold, FIG. 1A). Therefore, the measured C═O peak intensity was taken to be equivalent to the [1-¹³C]oleate in TG. For cells incubated with [1-¹³C]octanoate, the signals from direct incorporation of [1-¹³C]octanoate were less intense than the C═O signals from unlabelled TG (FIG. 1B; signals from unlabelled saturated acyl chains overlapped those of esterified [1-¹³C]octanoate, but were generally 30-40% of their unsaturated counterparts in control cultures). Therefore, the signal intensity from direct incorporation of [1-¹³C]octanoate was obtained by subtracting the background signal from control. This may not be completely accurate when octanoate incorporation is very limited. Nevertheless, these partial errors do not affect the general conclusions from this study (see below).

Measurement of total cellular DNA, TG and G3PD activity. Duplicate aliquots of homogenate were taken for DNA assays [28] and TG measurement (Sigma procedure no. 337 [27]). G3PD was measured by following the disappearance of NADH during enzyme-catalysed dihydroxyacetone phosphate reduction under zero-order conditions [29].

Methylation of TG and GLC analysis of fatty acyl composition. The lipid components of cell extracts were separated by TLC (hexane/ethyl ether/acetic acid, 70:30:1). Methylation was performed by incubation in BF3-methanol solution (14%, v/v, BF3 in methanol) at 60° C. for 30 min. The fatty acid methyl ester was extracted into a hexane solution. The hexane solution was dried with anhydrous sodium sulphate. To avoid the evaporation of methyl octanoate, the hexane solution was used directly for GLC study without further condensation. GLC analysis was performed on a Shimuzu 14A gas chromatograph with a Supelco SP™-2380 capillary column with an initial oven temperature of 150° C., final temperature of 240° C., heating rate of 4° C./min, injector temperature of 220° C. and detector temperature of 240° C. Carrier gas (He) was at 50 kPa, make-up carrier gas (He) at 100 kPa, hydrogen gas at 55 kPa and compressed air at 50 kPa. The sample was injected in 1-1.5 μl with splitting rate of 1:25.

Statistical analysis. Except when indicated otherwise, experiments presented here were repeated 36 times. The results were analysed using Microcal Origin (Microcal Software, Northampton, Mass., U.S.A.) and are presented as means±S.E.M. Student's t test was performed for selected results, and the P values are presented in the corresponding Figures.

### Example 1

### Both Octanoate and Oleate are Actively Metabolized by Fat Cells, However, Octanoate is More Oxidized than Stored

The partitioning of exogenous octanoate and oleate into the metabolic end products of CO2 and TG is shown in Table 2. Incorporation of either octanoate- or oleate-derived ¹⁴C isotopes into other lipid fractions (cholesterol, phospholipids and diglycerides) was much less extensive (results not shown). The data show that under identical culture conditions, octanoate partitioned into CO₂ more extensively than TG, but the opposite was found for oleate. The total number of mol of exogenous fatty acids converted into TG plus CO₂ within 60 min was similar. Considering that each octanoyl chain only produces 8 CO₂ molecules (eight times values in Table 2) whereas oleate produces 18 CO² molecules (18 times value in Table 2), the actual the amount of CO² produced from octanoate was about 3-fold greater than that from exogenous oleate.

TABLE 2
Exogenous octanoate and oleate incorporated into the metabolic
end products in 3T3-L1 adipocytes detected as CO₂ and
TG expressed as nmol of the corresponding fatty acids converted
into each product (nmol/h per μg of DNA)

| Sample | TG | CO2 |
|---|---|---|
| Octanoate | 0.9 ± 0.1 | 8.4 ± 1.2 |
| Oleate | 7.6 ± 0.8 | 0.7 ± 0.1 |

Since part of the acetyl-CoA derived from octanoate may be re-utilized for de novo synthesis of LCFA and incorporated subsequently into TG (see below), the amount of isotope recovered in the TG fraction may be more than the actual amount of octanoyl chain esterified into TG. However, since the amount partitioned into the de novo synthesis is less than 16% (as detected by ¹³C-NMR, see below), the results shown here still reflect the amount of [1-¹⁴C]octanoate esterified. Furthermore, the inclusion of de novo-synthesized LCFA in TG only supports, rather than averts, the conclusion that octanoate is more oxidized than stored. Means+S.E.M. are shown (n=3).

It is not possible to determine the endogenous fatty acid pool using this approach. This pool may also contribute to CO₂ production in cells exposed to octanoate and oleate. However, the results show that both octanoate and oleate are actively metabolized in 3T3-L1 adipocytes, and are in accord with previous observations that more octanoate is oxidized than stored in animal cells [1,36].

### Example 2

### Both Octanoate and Oleate are Direct Incorporated by Fat Cells into Cellular Lipids

The ¹³C-NMR spectra of lipid extracts from 3T3-L1 adipocytes incubated with [1-¹³C]octanoate or [1-¹³C]oleate for 24 hare shown in FIGS. 1(A) and 1(B). For comparison, a spectrum of the lipid extract from HepG2 cells incubated with [1-¹³C]octanoate for 24 h is shown in FIG. 1(C). The carbonyl signals are shown in the left-hand panels and aliphatic carbon signals in the right-hand panels. Spectra obtained under other incubation conditions had similar general features with different peak intensities.

[1-¹³C]oleate and [1-¹³C]octanoate were each found to be esterified to TG at the sn-1,3 as well as the sn-2 positions in fat cells (FIG. 1), represented by the peaks arising from the corresponding carbonyl resonances, TG(1,3) and TG(2). Such direct esterification of [1-¹³C]octanoate was not detected in HepG2 cells (FIG. 1C), whereas [1-¹³C]oleate was directly esterified in HepG2 cells [30] to an extent similar to that in fat cells (results not shown). The amount of [1-¹³C]oleate or [1-¹³C]octanoate incorporated into phospholipids was insignificant, as evidenced by the lack of corresponding resonances [25].

### Example 3

### Acetyl-CoA Derived from the β-Oxidation of Octanoate can be Utilized for de Novo Fatty Acid Synthesis and then Stored in Cellular Triglyceride

In principle, the acetyl-CoA derived from the β-oxidation of [1-¹³C]FFA can be used for de novo FFA synthesis. Any incorporation of [1-¹³C]acetyl-CoA into the acyl methylene would be detected by NMR. In previous studies on fat cells treated with oleate or palmitate, partitioning of exogenous fatty acids into this pathway was not detected [25,27,31]. However, for cells incubated with octanoate, it was found that the integrated intensities of some methylene peaks representing a single carbon (α+1, α−1, etc.) were about 2-fold more intense than the ωCH₃ peak (FIGS. 1B and 1C), indicating selective labelling of the aliphatic region with ¹³C isotope. Peaks for the αCH₂ and (α+1)CH₂ generally were broader or split because of the magnetic shielding from sn-1,3 or sn-2 carbonyls. Therefore, the peak heights of these signals were lower than the signals arising from the other methylenes even though they may have had the same overall integral intensity.

The lipid mixtures (of 3T3-L1 or HepG2) were then separated by TLC, and the TG and phospholipid fractions examined by NMR. The spectra from the phospholipid fractions were very weak and did not reveal any examined C signal enhancement. The spectra of the TG fractions were essentially the same as those before the separation, indicating that the signals detected in the spectra shown in FIG. 1 were from the TG fractions. This also shows that part of the [1-¹³C]acetyl-CoA derived from the β-oxidation of [1-¹³C]octanoate was used for de novo fatty acid synthesis and then stored in cellular TG. Since the NMR signal intensity from each ¹³C label is equivalent to that from 100 natural carbons, a 2-3-fold peak intensity corresponds to about 1-2% isotope enrichment. The observation that the (ω−1)CH₂ peak is more intense than the ωCH₃ peak indicates that [1-¹³C]acetyl-CoA can be used as the priming unit for the acyl chains. The peak intensity of ωCH₃ can be used as an intrinsic reference to detect the partitioning of ¹³C-labelled substrates in the de novo synthesis pathway.

### Example 4

### MCFA are Stored Less Than LCFA in Fat Cells

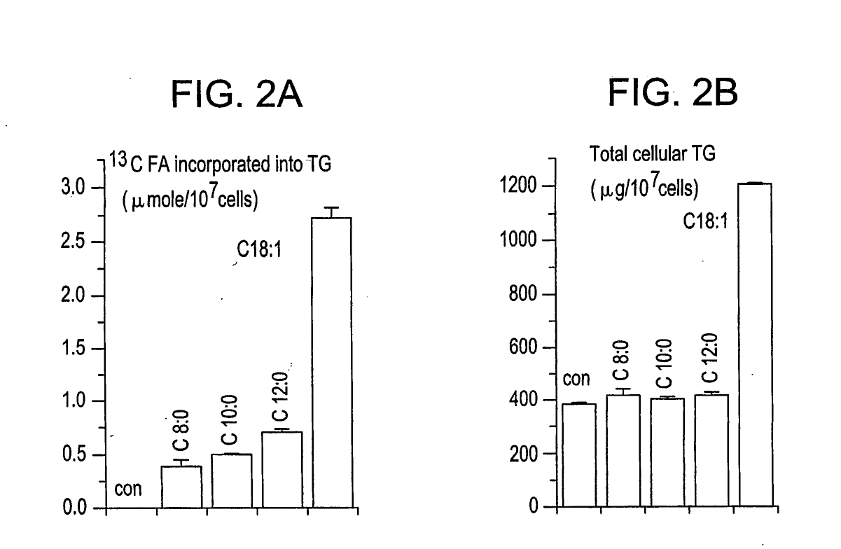

It is well accepted that MCFA are readily oxidized with minimal esterification into triglycerides in fat cells. Using a new NMR procedure, it could be demonstrated that octanoate was stored less than oleate, but still to a significant extent, implying that MCFA may have more metabolic influence on fat cells than simply a quick energy substrate. FIG. 2 compares the esterification rate of MCFA (C8, C10, C12) to that of LCFA (C18:1) in cultured adipocytes. The data clearly show that cells exposed to MCFA accumulated less lipid compared to those exposed to LCFA of equal concentration.

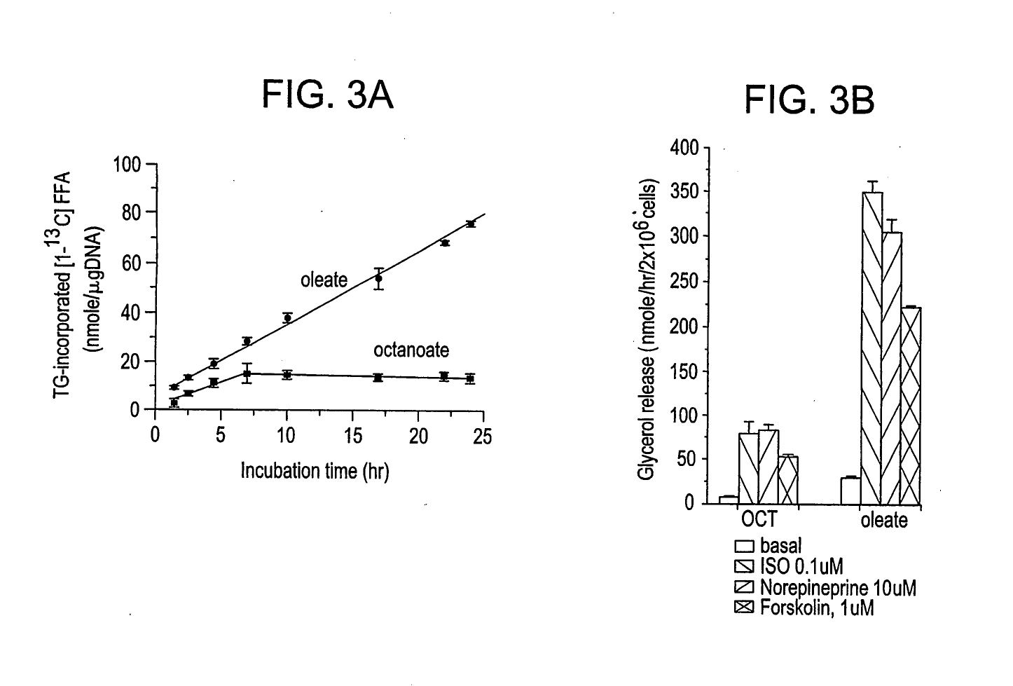

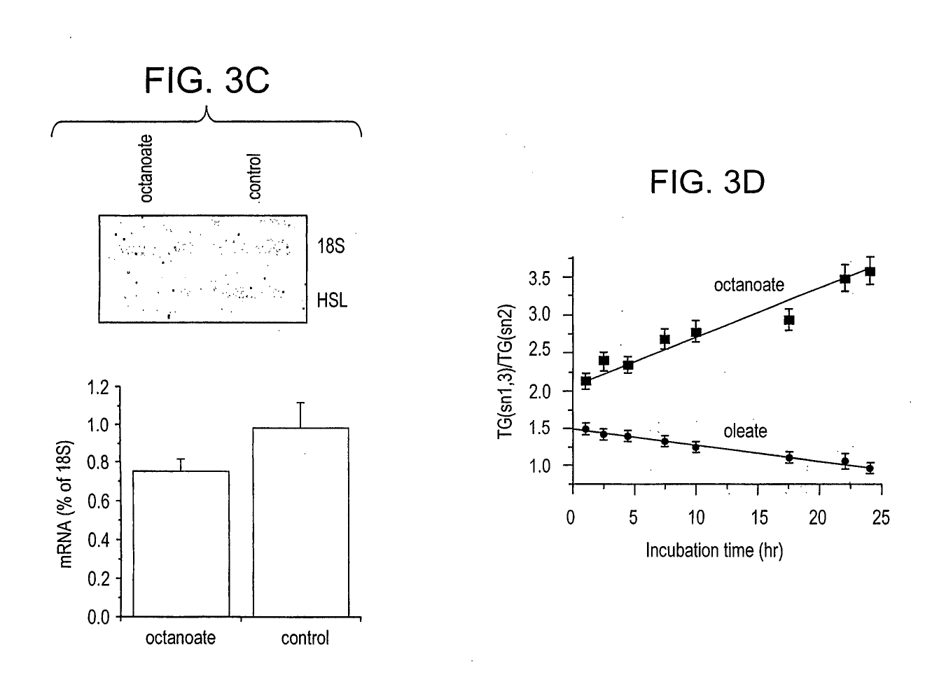

Moreover, the incorporation of MCFA into cellular lipids saturated at a low level irrespective of the incubation time, whereas that of LCFA continues to increase in proportion to the exogenous LCFA concentration and the incubation time (FIG. 3A). Within a 24-h period, the accumulation of oleate into TG increased with incubation time, whereas the accumulation of octanoate reached a plateau at 7 h. In 24 h, about four times more total [1-¹³C]oleate than [1-¹³C]octanoate was incorporated into TG.

To determine if the low rate of incorporation of octanoate into TG was related to substrate availability, cells were incubated with various concentrations (1-5 mM) of [1-¹³C]octanoate for 24 h. However, the incorporation of [1-¹³C]octanoate into lipid did not vary significantly with respect to octanoate concentration, as determined by NMR (results not shown). Hence, substrate availability (within the range investigated) was not rate limiting for the esterification of octanoate, and it is likely that the process was saturated. In other experiments, cells were incubated with [1-¹³C]octanoate for longer periods (up to 7 days), but did not result in a substantial increase in the incorporation of [1-¹³C]octanoate. Such saturation could be either due to limited incorporation or faster turnover of TG that contains octanoate.

Despite limited storage, octanoate can still influence adipocyte metabolic function. In particular, octanoate inhibits lypolysis induced by isoproterenol (Iso), norepinephrine (NE) and forskolin (FIG. 3B). Mechanistically, it is postulated that octanoate inhibits lypolysis by down-regulation of hormone-sensitive lipase (HSL). FIG. 3C demonstrates that 3T3-L1 adipocytes treated with 1 mM octanoate for 4 days resulted in reduced basal and stimulated lipolysis, consistent with a reduction in the mRNA level of HSL.

### Example 5

### Octanoate and Oleate Differ in the Glyceryl Position to Which they are Esterified

The extent of [1-¹³C]fatty acid esterification at the sn-1,3 or sn-2 positions on glycerol can be determined by the peak intensity ratio of TG(1,3)/TG(2). A ratio of 2.0 corresponds to random access of exogenous fatty acids to the three glycerol carbons. For cells incubated with oleate, this ratio was lower than 2.0, and decreased with incubation time (FIG. 3C), as found previously [27,31]. For cells incubated with octanoate, this ratio was higher than 2.0, and increased with incubation time (FIG. 3C). Hence, these two types of fatty acids not only have different overall storage rates, but also have different esterification rates at the three acyl chain positions in TG. The observation that octanoate has a higher preference for sn-1,3 positions agrees with the acyl specificity in animal milk [32].

### Example 6

### Oleate, but not Octanoate, Induces Fat-Cell Differentiation

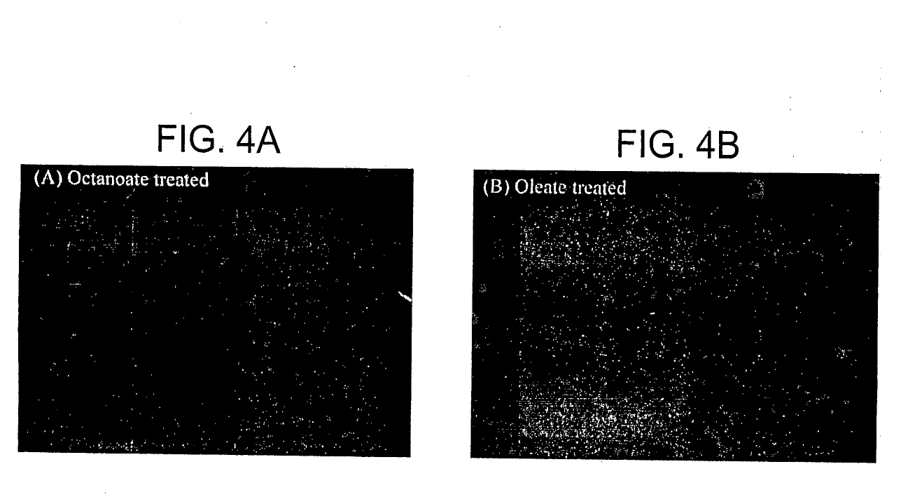

When added to undifferentiated cells (not treated with MDI), lipid droplets began to appear in cells treated with oleate 3 days after the incubation. In octanoate-treated and control cells lipid droplets began to appear 6 days after incubation, but to a much lesser extent than in cells treated with oleate. After 9 days of incubation, about 90% of the cells contained lipid droplets. The droplets in octanoate-treated cells (FIG. 4A) were much smaller than those in oleate-treated cells (FIG. 4B). After extended fatty acid incubation, there was about a 20% cell loss in oleate-treated cultures, as shown by microscopic examination (FIG. 4) and corroborated by DNA analysis. Such cell loss was less significant in octanoate-treated cells. Since the cells that lifted off were mostly differentiated fat cells (examined by microscopy), the cell loss was likely to be induced by the propensity of fat-laden cells to float rather than by fatty acid-related toxicity, although the rapid lipid accumulation in the presence of excess oleate may have accelerated this process. When cells were differentiated with MDI treatment and subsequently accumulated lipids mostly by de novo synthesis from glucose, cell loss was not significant up to 6 days after MDI treatment.

The total TG accumulated in oleate-treated cells was substantially greater than for cells treated with octanoate (Table 3). The TG thus accumulated contained mostly oleate (>80%) in oleate-treated cells, and mostly palmitate and palmitoleate in control or octanoate-treated cells (results not shown), indicating that the latter accumulate fat via a de novo pathway, as previously documented in 3T3-L1 cells [33,34].

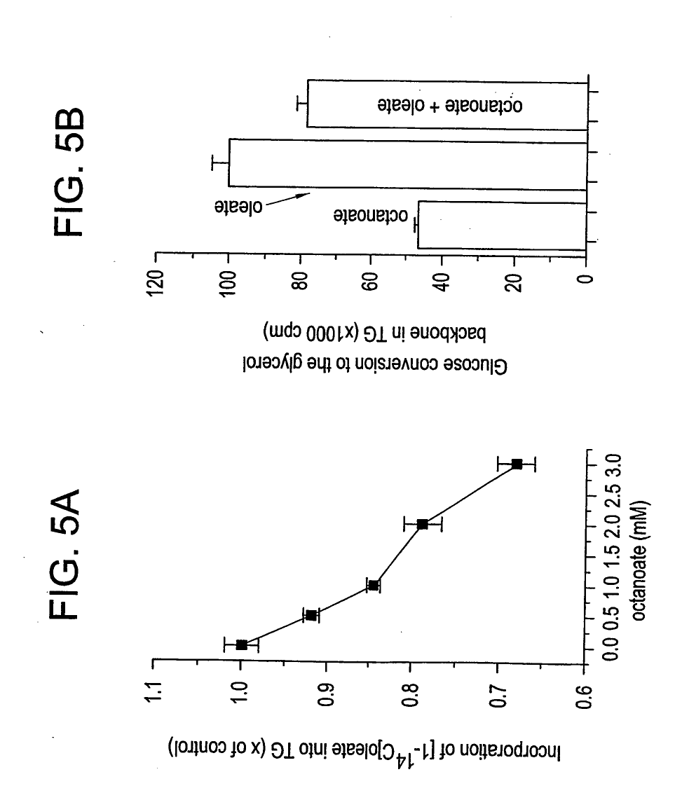

It was then determined whether the observed difference in cellular lipid storage was simply because less MCFA was esterified than LCFA or whether MCFA also affected the storage of LCFA. When [1-¹⁴C] oleate was added to the culture medium in the presence of unlabeled octanoate, the incorporation of ¹⁴C isotope into cellular lipids was decreased in proportion to the exogenous octanoate concentration (FIG. 5A). Since glycerol kinase activity is minimal in fat cells, glucose is the major supplier of the glycerol backbone for triglyceride synthesis. Therefore, the amount of [1-¹⁴C]glucose-derived isotope incorporated into the TG-glycerol backbone reflects the net TG synthesis in the cell. As shown in FIG. 5B, cells exposed to octanoate had a lower TG synthesis rate than cells exposed to oleate, and the replacement of oleate partially by octanoate reduced the net TG synthesis in adipocytes. These data demonstrate that MCFA down regulate lipogenesis and reduce adipocyte fat content.

To confirm that the TG storage was a result of cell differentiation rather than non-specific accumulation of exogenous fatty acids [35], G3PD activity, a commonly recognized differentiation marker, was analysed in cells thus treated. The results showed a close correspondence between G3PD activity and total TG stored (Table 3).

TABLE 3
The cellular TG content and G3PD activity in 3T3-L1 cells with
basal medium containing insulin (2.5 μg/ml) in the presence
of octanoate and oleate (means ± S.E.M., n = 3)

| | TG | | G3PD (nmol/min | |
|---|---|---|---|---|
| | (μg/μg of DNA) | | per μg of DNA) | |
| Sample | Day 6 | Day 9 | Day 6 | Day 9 |
| Control | 0.3 ± 0.05 | 0.5 ± 0.03 | 0.12 ± 0.02 | 0.3 ± 0.02 |
| Octanoate | 0.1 ± 0.02 | 0.6 ± 0.04 | 0.09 ± 0.01 | 0.2 ± 0.01 |
| Oleate | 1.7 ± 0.2 | 5.1 ± 0.3 | 0.45 ± 0.02 | 1.7 ± 0.1 |

*Cells were not treated with methylisobutylxanthine or dexamethasone.

It was concluded that incubation with oleate (in the presence of insulin) significantly promoted adipocyte differentiation in 3T3-L1 cells, resulting in higher storage of TG, whereas octanoate did not have such an influence.

### Example 7

### MCFA Inhibit Preadipocyte Differentiation into Fat Cells and Down Regulate Adipogenic Gene Expression in Mature Adipocytes

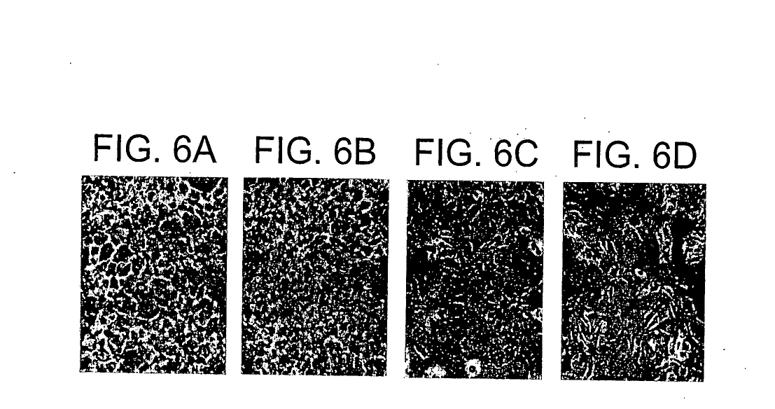

The effects of octanoate on adipocyte differentiation using 3T3-L1 preadipocytes were next studied. Cells were grown and treated with hormonal inducers (a combination of dexamethasone, 1 μM; methylisobutylxanthine, 0.5 mM; and insulin, 17 nM) according to standardized protocols in the presence of variable octanoate and oleate. On day 6 post differentiation induction, cells were stained for lipids by oil-red-O. As shown in FIG. 6, more than 75% of the cells in control had acquired lipid droplets (A). Adding-100 uM oleate significantly increased the amount of lipid accretion (B). Adding 100 uM oleate and 1 mM octanoate reversed the effects of oleate on lipid accumulation (C), and lipid accretion was minimal in cells exposed to 1 mM octanoate alone (D). Adding 2 mM or 3 mM octanoate further reduced the amount of lipid accretion (data not shown).

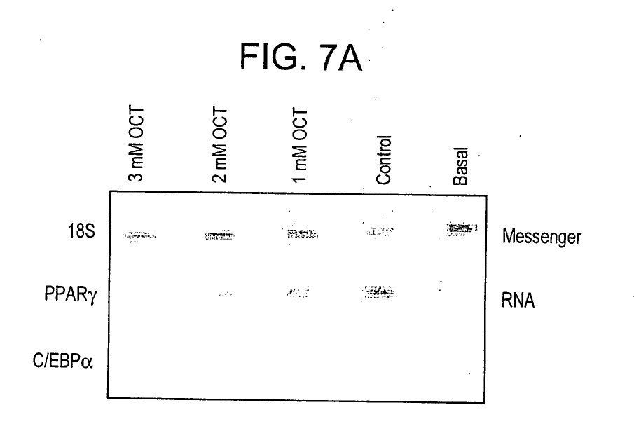

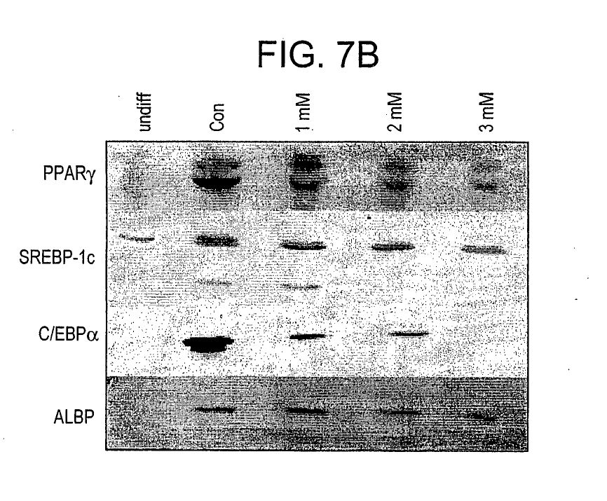

Adipocyte fatty acid homeostasis is determined by a number of metabolic enzymes that are regulated by two master transcription factors, peroxisome proliferation activator receptor γ (PPARγ) and CCAAT enhancer binding protein α (C/EBPα). As shown in FIG. 7, exposure to octanoate largely suppressed the expression of these master transcription factors at both the “mRNA and protein levels. At the end of day 8^{th} after the initiation of differentiation, expression of the master transcription factor, sterol regulatory element binding protein-1c/adipocyte determination- and differentiation-dependent factor 1 (SREBP-1c/ADD1), was also significantly lower in octanoate treated cells than control at both mRNA and protein levels. By contrast, MDI induced decrease of Pref-1, a transcription factor that maintains preadipocyte phenotype, was not affected by octanaote. Such inhibition was selective for adipogenesis, as octanoate had no effect on the rRNA level of 18S (FIG. 7). Other differentiation markers, including adipocyte lipid-binding protein/adipocyte fatty acid binding protein (ALBP/aP2), glycerol-3-phosphate dehydrogenase (GPDH), and leptin, were also diminished by octanoate. (See also Han, 2001).

Synthetic PPARγ ligands partially restored the mRNA level of PPARγ, but failed to rescue the entire differentiation program. Over-expression of a dominant positive form of C/EBPα (LAP) also failed to overcome the inhibitory effects of octanoate on differentiation. Furthermore, time course experiments revealed that at the initial stage (24-60 hours after adding the hormone cocktail), expression of PPARγ and C/EBPα appeared earlier and more intense in octanoate treated cells than in the control. However, as the expression of these adipogenic transcription factors progress to peak at 4-6 days post MDI treatment in the control, those in octanoate treated cells became gradually diminished. Apparently, the initial expression of PPARγ and C/EBPα in octanoate treated cells did not turn on the lipogenesis as evident by the minimal levels of GPDH expression and lipid accretion. These results indicate octanoate did not prevent the initiation of differentiation. Instead, octanoate might act as a weak ligand for PPARγ, thus stimulating initial expression at a even earlier stage than control because the latter is regulated by the binding of endogenous ligands that have not yet been produced to a sufficient extent. The binding of octanoate as a weak ligand, but in large excess, either attenuates the production of endogenous ligands or prevents them from efficient binding to PPARγ, thus blocking the ultimate activation of adipogenesis.

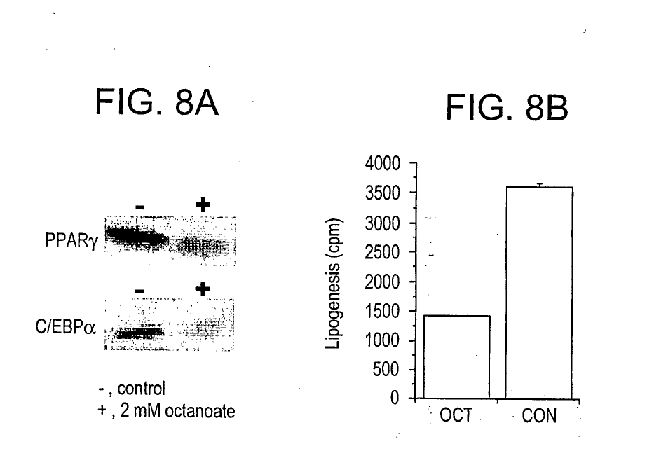

Moreover, when octanoate was added to mature adipocytes, it also down-regulated the expression of these two master transcription factors (FIG. 8, left) and reduced lipogenesis (FIG. 8, right). Together, these results show that MCFA can have a significant impact on fat cell development and metabolism in vitro. The data are summarized in Table 4.

TABLE 4
Octanoate selectively alters adipocyte metabolic
genes and their transcription factors

| Down-regulated | Not changed | Up-regulated |
|---|---|---|
| PPARγ, C/EBPα, | HPRT | MCAD, |
| SREBP-1c | 18S | CPT-1 |
| GPDH, Leptin, | Pref-1 | |
| HSL, ALBP | PPARα | |

Together, these results suggest that octanoate may diminish fat cell development by (i) reduced fat cell recruitment from preadipocytes and (ii) decreased fat storage in mature adipocytes.

### Example 8

### Octanoate Incorporation Increased as Differentiation Progressed

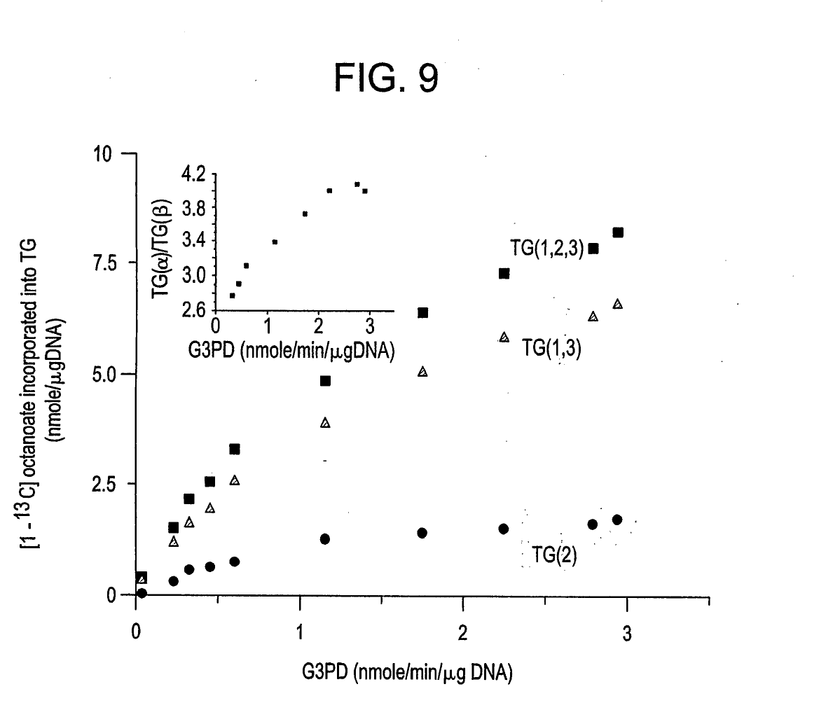

Incorporation of [1-¹³C]octanoate was nearly undetectable in undifferentiated cells. A gradual increase in direct esterification of [1-¹³C]octanoate occurred as cells progressed to later stages of differentiation, using G3PD as a marker of differentiation (FIG. 9). The incubation with octanoate in this experiment was performed from day 0 to day 6 after MDI treatment. Incorporation of octanoate at the sn-2 position reached a plateau early in differentiation whereas incorporation at the sn-1,3 position continued to increase, resulting in an increase in the TG(1,3)/TG(2) ratio (FIG. 9, inset).

### Example 9

### Glycerol Release from Cells Pre-Treated with Oleate or Octanoate

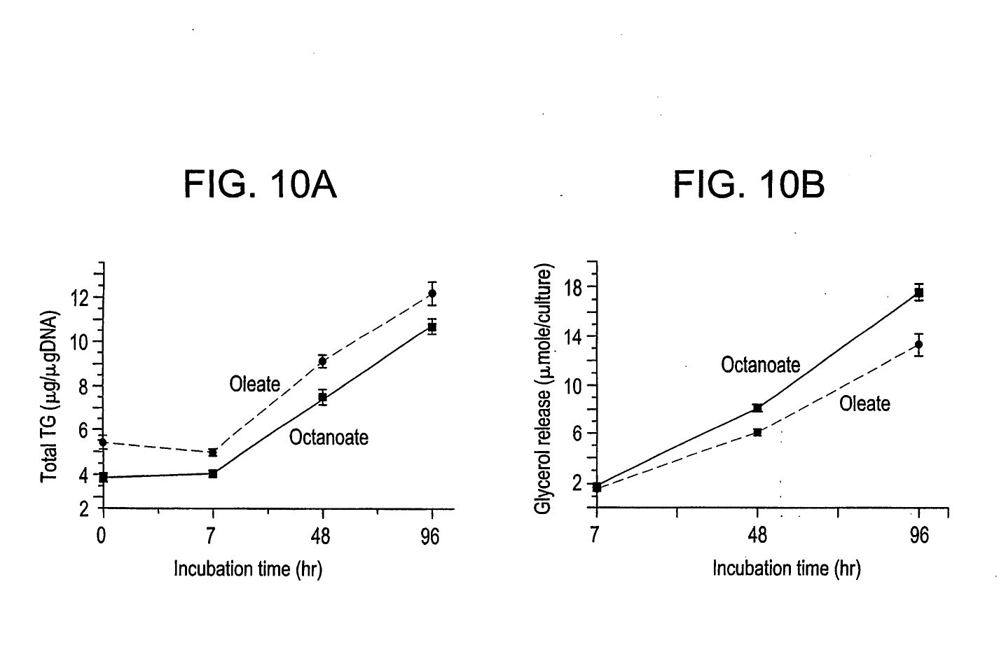

To compare the effects of oleate and octanoate on TG hydrolysis, cells pre-treated with the corresponding fatty acids were incubated with lipid-free DMEM (1% BSA). The total DNA values per culture assayed at 0, 7, 48 and 96 h were essentially unchanged (139±4 μg/culture), and there was no difference between cells treated with oleate or octanoate. Total cellular TG continued to increase, and slightly more than doubled in 96 h (FIG. 10A). The slightly higher TG storage in oleate-treated cells was likely to be a result of more extensive storage of exogenous oleate than octanoate during the 16-h pre-treatment period. The steady rate at which stored TG increased thereafter indicates that de novo synthesis of LCFA was not affected differently by octanoate or oleate pretreatment, and was not hampered by serum deprivation during the time course.

Despite a slightly lower cellular TG content, cells treated with octanoate released more glycerol than cells treated with oleate after 48 and 96 h of incubation (FIG. 10B). Glycerol release was linear with incubation time, and comparable with the reported values in basal lipolysis [33].

### Example 10

### Octanoate Turnover is Faster than Oleate During Lipolysis

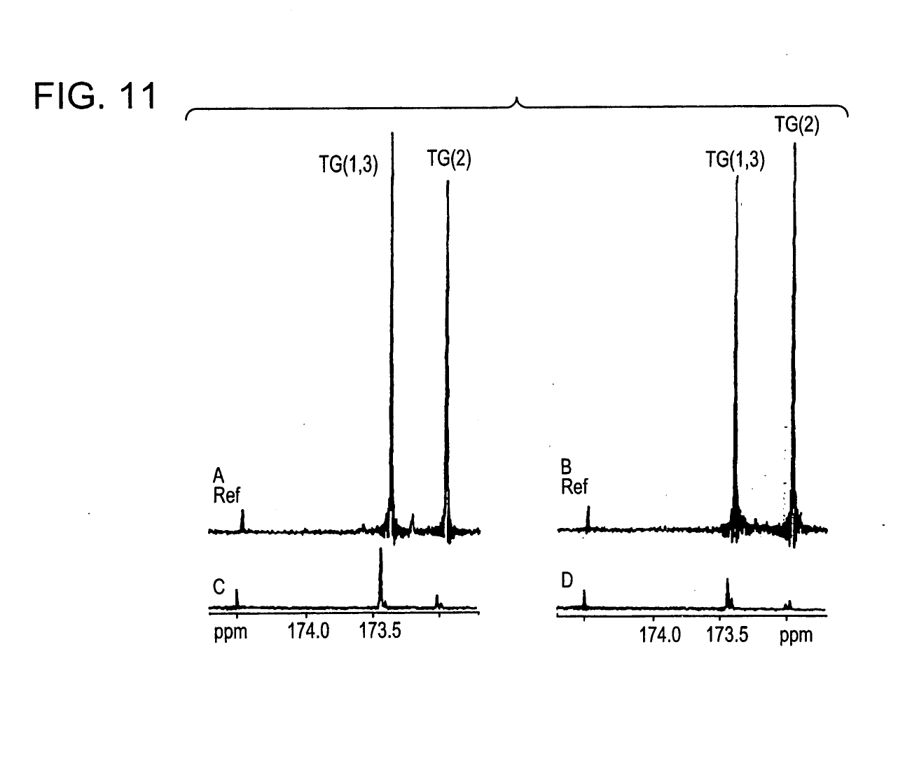

The turnover rate of [1-¹³C]FFA incorporated in TG can also be measured by NMR. As shown in FIGS. 11A and 11B, the total intensity of the [1-¹³C]oleate signal was similar before and after the 96-h incubation with DMEM. This indicates that most of the [1-¹³C]oleate remained esterified to TG (including unhydrolysed and hydrolysed but re-esterified oleate), as reported previously [27]. Some of the [1-¹³C]oleate released from the sn-1,3 positions may have been re-esterified at the sn-2 position, because the ratio of TG(1,3)/TG(2) decreased from about 1.2 (FIG. 11A) to less than 1.0 (FIG. 11B). Based on the integrated signal intensities, over 99±3.3% (±S.E.M.) of the [1-¹³C]oleate remained in TG (n=3).

The aliphatic regions (results not shown) of spectra (C) and (D) were both similar to that shown in FIG. I B, implying no significant changes in the utilization of [1-¹³C]octanoate for de novo synthesis of LCFA.

On the other hand, incorporation of [1-¹³C]octanoate was initially lower than oleate, but the absolute amount of incorporation was significant compared with the control (FIG. 11C). After the 96-h incubation with DMEM, signals from [1-¹³C]octanoyl chains were largely decreased at the sn-1,3 position, and completely depleted at the sn-2 position (FIG. 11D). About 21±1.2% (±S.E.M.) of the [1-¹³C]octanoate remained esterified in TG (n=3).

Table 5 shows the acyl chain composition in cellular TG fractions determined by GLC. For cells pre-treated with [1-¹³C]oleate, the percentage of fatty acyl chains in cellular TG was in the order: oleate>palmitoleate>palmitate. The predominance of oleate corresponds to the rapid uptake and storage of exogenous [1-¹³C]oleate. After the 96-h incubation with DMEM, this order changed to palmitoleate>palmitate>oleate. The proportion of oleate declined by 50%. Since the amount of total TG was approximately doubled during this period of time, this result indicates that the absolute amount of oleate in TG did not change significantly. Instead, the reduction in the proportion of oleate was due to increases in palmitoleate and palmitate.

TABLE 5
Fatty acid composition of cellular TG before and
after 96 h of incubation with DMEM (1% BSA)
in cells pre-treated with oleate and octanoate

| | Oleate | | Octanoate | |
|---|---|---|---|---|
| Acyl chains | Before | After | Before | After |
| 8:0 | 0 | 0 | 10.33 ± 0.3 | 0.99 ± 0.05 |
| 14:0 | 2.84 ± 0.09 | 3.28 ± 0.02 | 3.74 ± 0.04 | 3.88 ± 0.21 |
| 14:1 | 4.75 ± 0.08 | 5.48 ± 0.03 | 5.56 ± 0.29 | 5.78 ± 0.11 |
| 15:0 | 1.02 ± 0.04 | 1.36 ± 0.02 | 1.43 ± 0.14 | 1.63 ± 0.17 |
| 15:1 | 0.81 ± 0.01 | 1.24 ± 0.09 | 1.4 ± 0.14 | 1.41 ± 0.09 |
| 16:0 | 20.01 ± 0.36 | 23.65 ± 0.03 | 24.62 ± 0.35 | 24.45 ± 0.03 |
| 16:1 | 27.34 ± 0.29 | 38.65 ± 0.2 | 38.61 ± 0.2 | 47.64 ± 0.34 |
| 17:0 | 0.82 ± 0.03 | 0.75 ± 0.03 | 0.9 ± 0.03 | 0.85 ± 0.096 |
| 17:1 | 3.31 ± 0.26 | 3.98 ± 0.07 | 3.89 ± 0.1 | 4.73 ± 0.12 |
| 18:0 | 0.38 ± 0.04 | 0.41 ± 0.02 | 0.49 ± 0.02 | 0.51 ± 0.16 |
| 18:1 n9 | 36.4 ± 0.4 | 19.71 ± 0.02 | 6.69 ± 0.09 | 6.2 ± 0.29 |
| 18:1 n11 | 1.35 ± 0.07 | 1.51 ± 0.12 | 2.34 ± 0.05 | 1.95 ± 0.13 |

*Results are shown as percentages (means ± S.E.M., n = 3). The appearance of odd-number chain-length fatty acids is typical in 3T3-L1 fat cells as a result of de novo synthesis [50]. Other fatty acids, including C18:2 and C18:3, were also detected, but to a lower extent.

For cells pre-treated with [1-¹³C]octanoate, the acyl chains of TG were predominantly palmitoleate and palmitate (Table 5). Octanoate incorporation amounted to 10±0.9% (n=3) of total acyl composition. After the 96-h incubation with DMEM, the proportion of octanoate in total stored fatty acids was reduced to about 1±0.1% (n=3). Considering that the total TG content doubled during this period (96 h), the absolute amount of octanoate that remained in TG was about 20% of the original amount (10%), a figure that agrees with the N results (FIGS. 11C and 11D).

To determine whether the released octanoate accumulated in the medium, the fatty acid composition of the incubation medium was analysed. The fatty acids detected were mainly palmitate and palmitoleate, with no detectable octanoate and only an insignificant amount of oleate. Together, these results suggest that when deprived of exogenous lipid supply, [1-¹³C]oleate is largely conserved in the cellular TG [27], whereas [1-¹³C]octanoate is largely dissipated, probably through oxidation.

### Summary of Examples 1-10

Fatty acids of different chain lengths have different effects on cellular processes. Whereas the pathological roles of saturated compared with unsaturated LCFA are well established [36], the effects of MCFA are far less understood. The data presented in Examples 1-10 address issues including how much octanoate is stored by fat cells, how it perturbs the molecular structure of TG, and how it affects cell differentiation. The data demonstrate major differences between octanoate and oleate in their oxidation, esterification and release from TG and their influence on adipocyte differentiation. It has been widely accepted that MCFA are mainly oxidized in cells through the carnitine-independent pathway whereas LCFA may be stored or oxidized depending on the economy of other fuels [37]. This argument has been used to explain the low storage rate of MCFA in fat cells [17]. However, there is evidence that MCFA can be esterified in TG in the liver [38] and fat cells [21,39], which is confirmed by the above-presented in vitro data.

First, it is demonstrated that octanoate is stored in differentiated fat cells but not in undifferentiated preadipocytes (FIG. 9), although oleate can also be stored in undifferentiated fat-cell precursors [27]. Storage of octanoate increases as cells became more differentiated until a maximum level is reached. It is well known that MCFA have a low affinity for cytosolic acyl-CoA synthase [40], but can be readily activated within the mitochondrial matrix for oxidation. Both factors might lead to relatively low cytosolic substrate availability for esterification. However, these may not be the sole reasons for the low rate of MCFA storage, because increasing the substrate concentration of octanoate (up to 5-fold) and extending the incubation period does not increase the proportion of octanoate in stored fat. Another related factor may be the pool of carnitine, which is needed to transport octanoyl-CoA from the mitochondria to the cytosol, and the pool of CoA, which increases with differentiation (unpublished work) and could lead to an increase of octanoyl-CoA concentration in the cytosol.

Second, it was demonstrated that when stored, octanoate is mostly esterified at the sn-1,3 positions. Esterification of a medium chain to the sn-2 position may be thermodynamically unfavourable. Monoacylglycerol acyltransferase may have a higher affinity for LCFA than MCFA so that most of the acyl chains delivered to the sn-2 position are from LCFA, especially unsaturated LCFA [41]. In addition, the incorporation of MCFA might be mostly accomplished via de-acylation/re-acylation of existing TG molecules, whereas incorporation of LCFA may also be accomplished via the synthesis of new TG molecules directly from free fatty acids and α-glycerolphosphate. This is particularly relevant it can be shown that MCFA are not esterified in cells that have not acquired a suitable amount of TG, whereas the storage of LCFA does not have such a pre-requisite. Since the turnover of sn-1,3 chains in TG is more active than sn-2 chains [31], it is not surprising that more MCFA are esterified at the sn-1,3 positions.

The observation that octanoate incorporation in fat cells becomes saturated and accounts for about 10% of total fatty acids is consistent with previous studies in vivo. [21]. When converted to a molar scale, this accounts for 20% of the total acyl chains stored in fat cells, an amount that would be predicted to have substantial effects on cellular metabolism. In contrast to the above demonstration that octanoate turnover is much faster than that of oleate (FIG. 11), storage of MCFA in infant subcutaneous fat was previously shown to be rather stable and remained unchanged 1 week after switching to a MCT-free diet [21]. This is likely because subcutaneous-fat turnover rate is intrinsically lower than that in visceral fat since it serves mainly as thermal insulation and mechanical cushioning [42]. Furthermore, visceral fat is affected more by dietary modulation than peripheral fat.

Third, a significant finding resulting from the above-described stuies is that fat cells pre-treated with octanoate have a significantly enhanced TG hydrolysis (FIG. 10). This finding has not been reported before. It may be argued that less TG storage in cells pre-treated with octanoate results in smaller fat droplets and thus a larger surface area of lipids. However, the cells we used were well differentiated before they were treated with octanoate, and there were no microscopic differences in cell morphology or fat droplet size examined by phase contrast microscopy. The difference in total stored TG was rather small between cells pre-treated with octanoate or oleate, and could not account for the difference in glycerol release (FIG. 10). Instead, the results suggested that incorporation of octanoate may facilitate TG hydrolysis. Since the hydrolysis product MCFA diffuses away from the site of reaction more rapidly than LCFA, the lipase efficiency is higher for MCT than LCT [43]. Furthermore, hydrolysis at the sn-1,3 position is the rate-limiting step in TG lipolysis [44]. Hence, the findings of the preferential incorporation of octanoate at the sn-1,3 position and the increased glycerol release in octanoate pre-treated fat cells fit together logically.

Yet another significant finding is that the MCFA, octanoate, can actually decrease the amount of LCFA (e.g., oleate) stored as TGs in fat cells.

Finally, another important observation is that octanoate, in contrast to oleate, does not stimulate fat cell differentiation, even after an extended incubation period. The eventual lipid accumulation is similar to that seen in control cells as a result of limited spontaneous differentiation in the presence of insulin and glucose [34]. In contrast, incubation with oleate rapidly induces differentiation with characteristic marked TG accumulation and increased G3PD activity. This is consistent with previous reports that LCFA induce the expression of genes involved in fatty acid metabolism [45-47]. This may explain the observation that weaning rats on MCT diets have lower fat-cell numbers as adults compared with their littermates on LCT diets [10]. Furthermore, long-chain CoA esters, but not short- or medium-chain CoA esters, are potent modulators of metabolic enzymes and signal transduction [48,49]. The fact that LCFA induces preadipocyte differentiation in vitro may also correlate with the observations that animals and humans on high-fat diets usually acquire more fat cells than controls [50-52]. Moreover, octanoate can inhibit differentaition of preadipocytes cultured in the presence of hormonal inducers of differentiation. The above-described findings support the hypothesis that replacement of part of the LCFA in conventional high-fat diets with MCFA at critical times in development can serve as a means to control cell number and decrease lipid accretion.

### Example 11

### Replacing Part of the Dietary LCT with MCT Fed to Young Mice Led to Reduced Body Weight Gain in Spite of Increased Food Intake

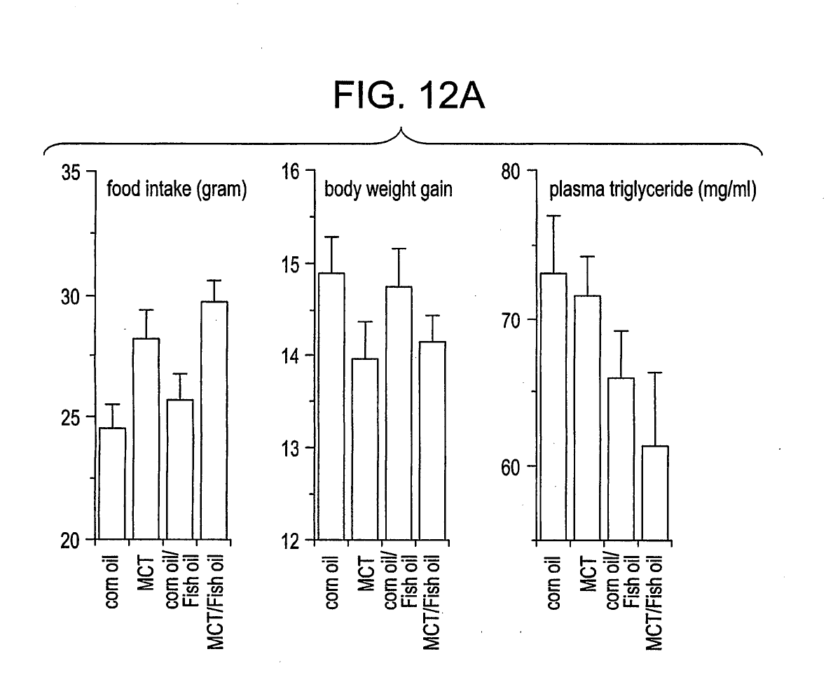

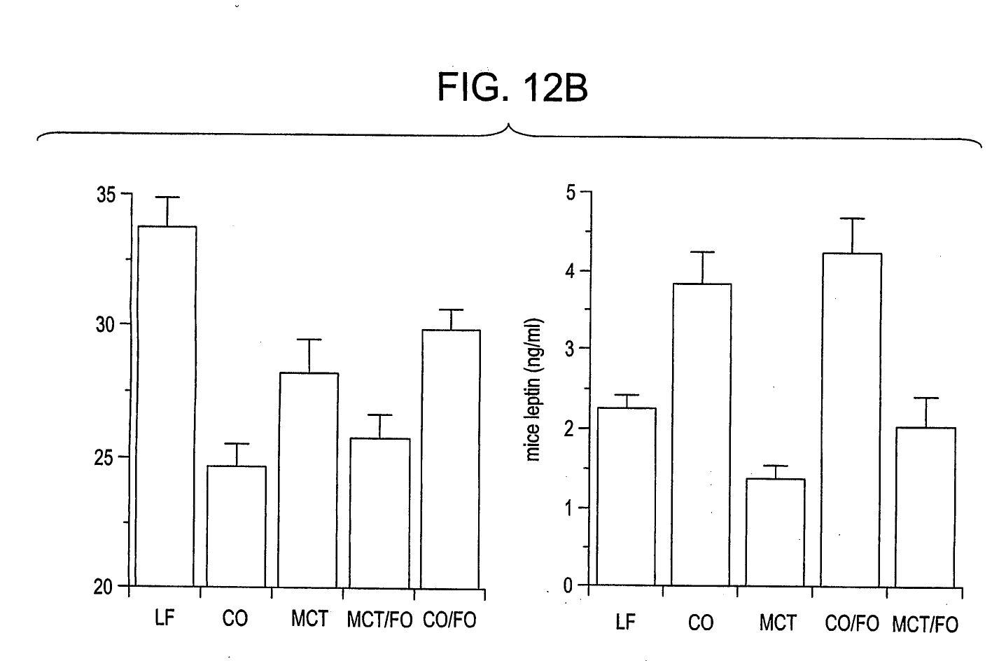

Although others have shown that feeding MCT by itself reduced body fat mass development in rats, controversial observations exist regarding the feeding period and the fat percentage in the diets. To assess the feeding effect under a more realistic condition, we tested the feeding effects of coconut derived MCT oil in comparison with corn oil and their mixtures with fish oil (MCT:FO=4:1 or CO:FO=4:1). The four types of oil were each mixed with standard chow meal (oil:meal powder=1:4, wt/wt). Animals were housed in a light and temperature controlled facility with free access to food and water. The results of food intake, body weight gain, and plasma triglycerides on week 6 are shown in FIG. 12A. FIG. 12B further demonstrated that MCT fed animals had reduced plasma leptin despite increased food intake (LF, low fat, 5% corn oil). Although MCT feeding only led to a minor decrease in body weight gain, the combined effects on increased food intake and reduced weight gain is striking.

### Example 12

### A Combination of MCFA and DHA Reduces Lipogenesis, Lipid Storage, and Secretion from Liver Cells

One of the major concerns of applying MCT in human trials has been that it usually raise the percentage of C16:0 and C18:1, the common products of de novo fatty acid synthesis. It has been reported that MCFA inhibits the acetyl-CoA carboxylase gene cultured chicken hepatocytes (Hillgartner, 1997). To address the possible adverse effects of the MCT diet on plasma lipid profiles by increasing de novo synthesis of LCFA, fish oil was used as a supplement to MCT in the dietary treatment experiments (FIG. 12). Because the ω-3 long chain fatty acids (EPA and DHA) have been shown to efficiently inhibit fatty acid synthesis, it is proposed that mixing MCFA with a small portion of EPA or DHA will synergize the positive effects of both types of fatty acids in reducing fat storage in adipose tissue and fat production in the liver.

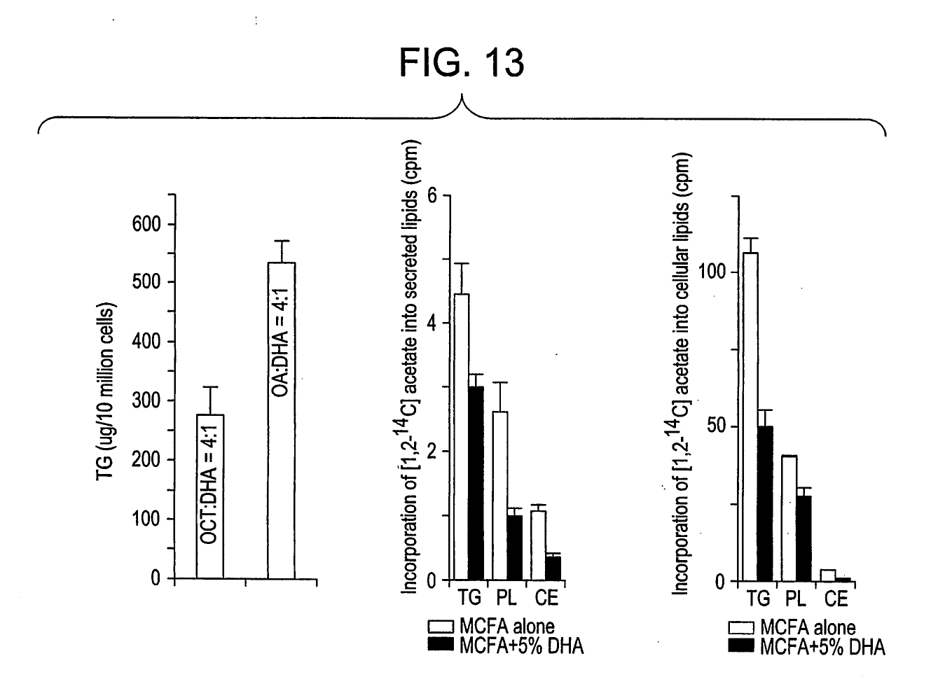

To test this proposal, HepG2 cells (human hepatoma cells) were treated with these fatty acids. FIG. 13 (left panel) shows that with the same concentration (20 uM) of added DHA, cells exposed to 180 uM oleate accumulated much more cellular triglycerides than cells exposed to 380 uM octanoate, indicating that replacement of LCFA with MCFA would reduce fat storage in liver cells. To assess the effects of DHA on de novo fatty acid synthesis, the incorporation of [1,2-¹⁴C] acetate into cellular (FIG. 13, middle panel) and secreted (FIG. 13, right) lipids was measured. The results clearly demonstrated that 5% DHA added with octanoate significantly reduced the incorporation of acetate into all three major lipid classes produced and secreted from the liver. Since DHA is one of the ω-3 PUFA naturally present in milk (Cherian, 1996) and can be further enriched by feeding marine algae to cows (Franklin, 1999), a combination of MCFA and ω-3 PUFA in milk can serve as a valuable dietary fat source for the regulation of fat mass development.

### Example 13

### Preparation of MCT-Enriched Milkfat Component

Milk-fat will is prepared from whole milk of a commercial source by ultra-centrifugation. The collected milk fat is hydrolyzed into free fatty acids by alkaline cleavage (30% KOH in ethanol, heat to 75° C. for 2 hours). After acidification, LCFA forms a lipid layer that separates from the aqueous phase in which the MCFA are enriched. The fatty acids thus obtained are re-esterified into MCT-enriched triglycerides by standard chemical procedure and used as dietary supplements, preferably for use as a milk product (e.g., reduced fat or non-fat milk product) supplement. The acyl chain composition in each fraction can be confirmed by gas-lipid chromatography as described previously. The chemistry principles used in this procedure are well established. Optionally, 5% fish oil can be added to the supplement or product to maintain a balanced ω-3 PUFA intake.

The fatty acid profile of the above-described modified fat product is presented in Table 6.

TABLE 6
Fatty Acid Profile
FATTY ACID PROFILE OF PRODUCT

| | % of TOTAL |
|---|---|
| FATTY ACID | FATTY ACIDS |
| MCFAs | 70-80% |
| (C6:0-C12:0) | |
| LCFAs | 10-20% |
| (C14:0-C18:0, C16:1, C18:1) | |
| PUFAs | 5-10% |
| (C18:2, C18:3, DHA, EPA, etc) | |

### Example 14

### Preparation of Modified Dietary Fat Supplement

MCFA Exposure Alters the Fatty Acid Composition of Cellular Lipids

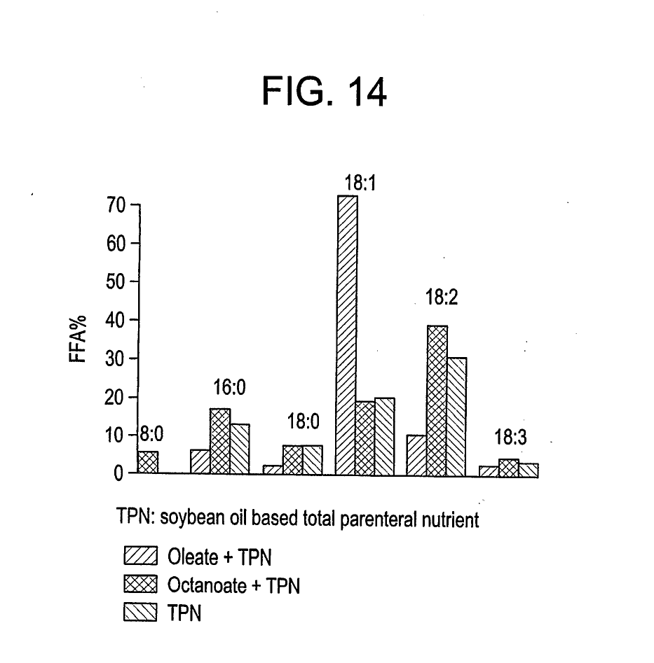

It has been shown that PUFA are more rapidly oxidized than saturated LCFA (Leyton, 1987). Rats on an MCT diet can spare linoleate from oxidation (Kaunitz, 1960). In our studies in rat preadipocytes, we found that the fatty acid composition of stored lipids changed significantly when cells were exposed to soybean-based TPN supplemented with oleate or octanoate. Octanoate, while directly esterified to a limited extent, increased the percentage of linoleate and linolenate in stored fat (FIG. 14). However, incubation with oleate substantially raised the percentage of oleate, but caused a large decrease in the percentage of linoleate, and a similar decrease in linolenate in stored fat. These data demonstrate that octanoate is significantly more effective at inducing essential fatty acid storage when compared to oleate.

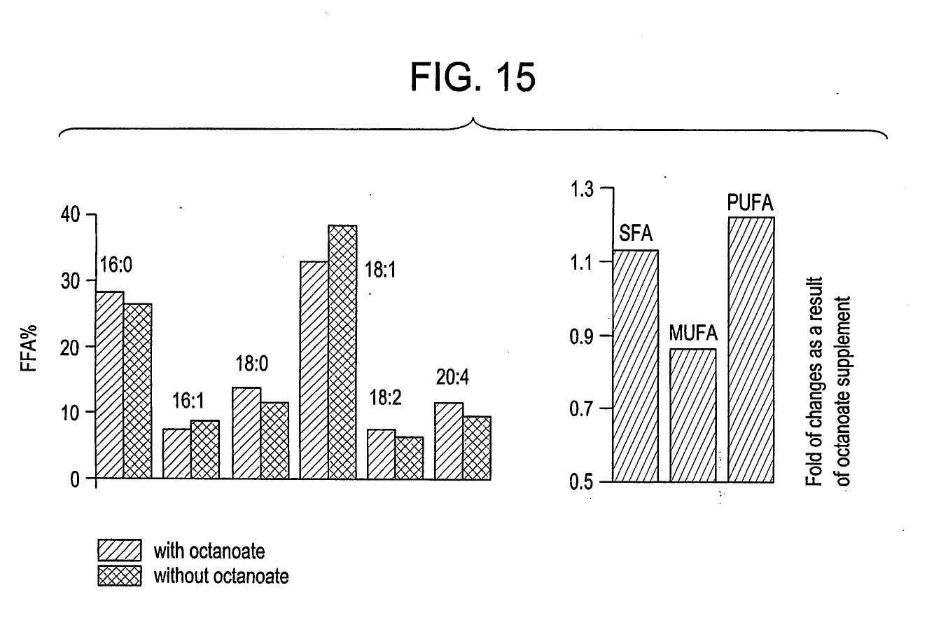

Additionally, we studied effects of octanoate on the plasma membrane fatty acid composition in 3T3L1 fat cells incubated with oleate/linoleate by replacing 20% (wt %) of the oleate with octanoate. This reduced the cellular TG storage from 41.5 to 27.0 μg/μgDNA. The fatty acid composition in the plasma membrane phospholipids (FIG. 15) was less drastically affected by exogenous fatty acids than that in the TG fraction (FIG. 14). However, replacement of 20% oleate by octanoate still resulted in ˜20% increase in PUFA, ˜10% increase in SFA, and ˜15% decrease in MUFA in the plasma membrane phospholipids (FIG. 15, right panel).

### Example 15

### MCT Diet Affects Animal Growth, Food Intake and Body Weight

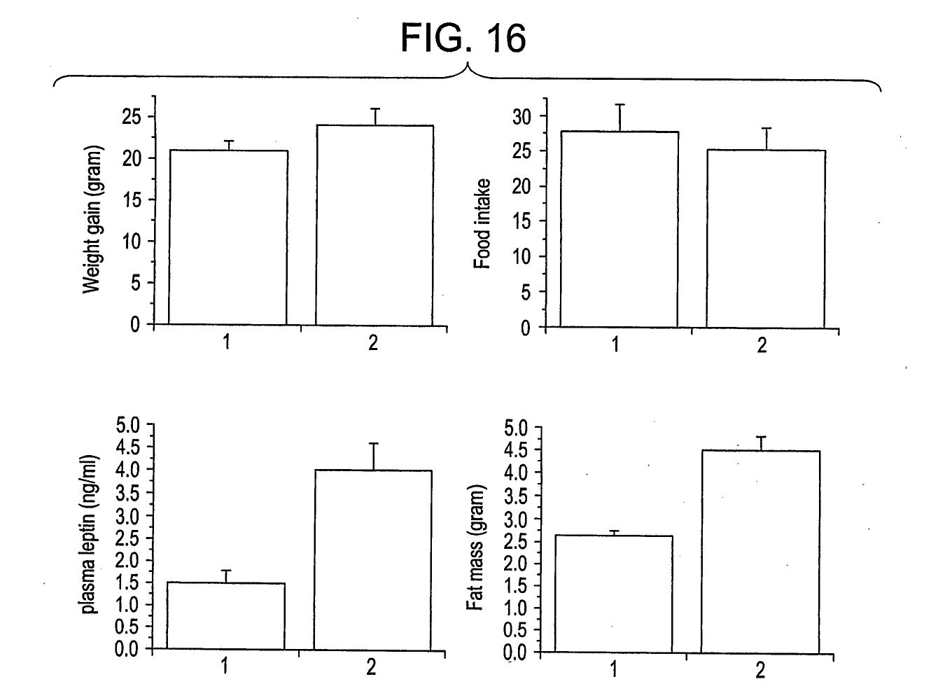

The data presented in Example 11 demonstrated that replacing part of the dietary LCT with MCT fed to young mice for 6 weeks led to reduced body weight gain in spite of increased food intake. The data presented in FIGS. 16-19 provide in vivo evidence that mice fed with MCT diet for longer periods of time not only gained less weight than those fed with LCT diet, but this effect was due to a reduction in body fat without observable efffects on lean muscle mass or bone density.

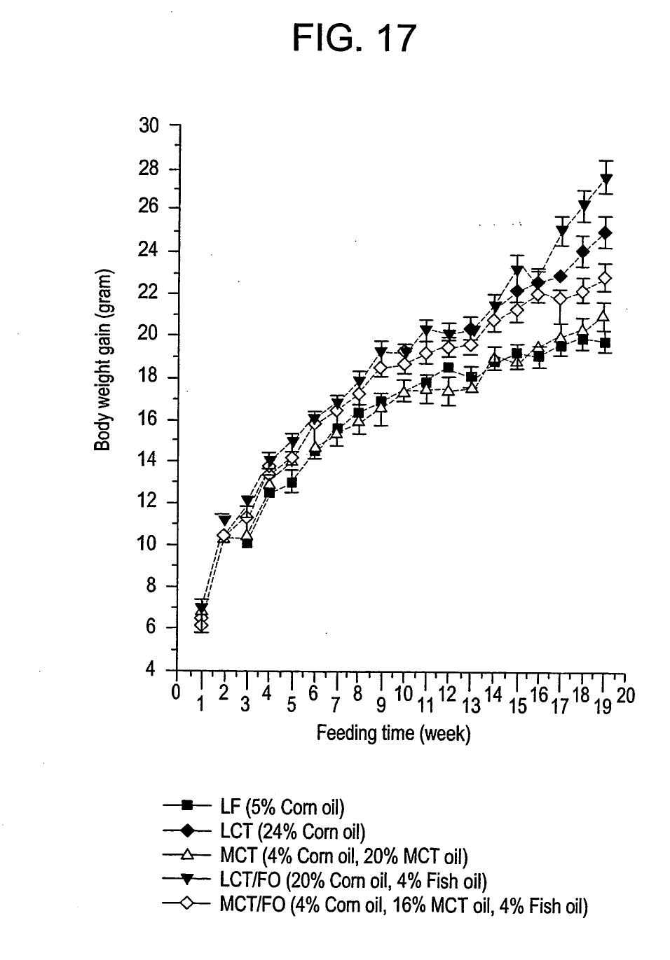

FIG. 16 shows data collected from mice after 19 weeks of feeding the MCT diet. Briefly, C57BL/6J wide type mice were fed high fat diet (40% fat calorie) beginning at the age of 21 day. After 19 weeks of feeding, animals on MCT diet gained less body weight, less fat mass, and lower plasma leptin level, but with little change in dietary intake level. Fat mass determination was performed by dual X-ray scanning. FIG. 17-19 show data collected from mice after 25 weeks of feeding the MCT versus low fat (LF) or LCT diets.

FIG. 17 demonstrates that mice fed the MCT diet have consistent lower body weight gain. C57BL/6J mice were fed diets supplemented with low fat (LF, 5% corn oil), high fat (LCT, 24% corn oil), MCT (4% corn oil, 20% MCT oil), LCT/FO (20% corn oil, 4% fish oil) or MCT/FO (4% corn oil, 16% MCT oil, 4% fish oil) diet beginning at the age of 25 days (n=8). Body weight and food intake were measured once a week.

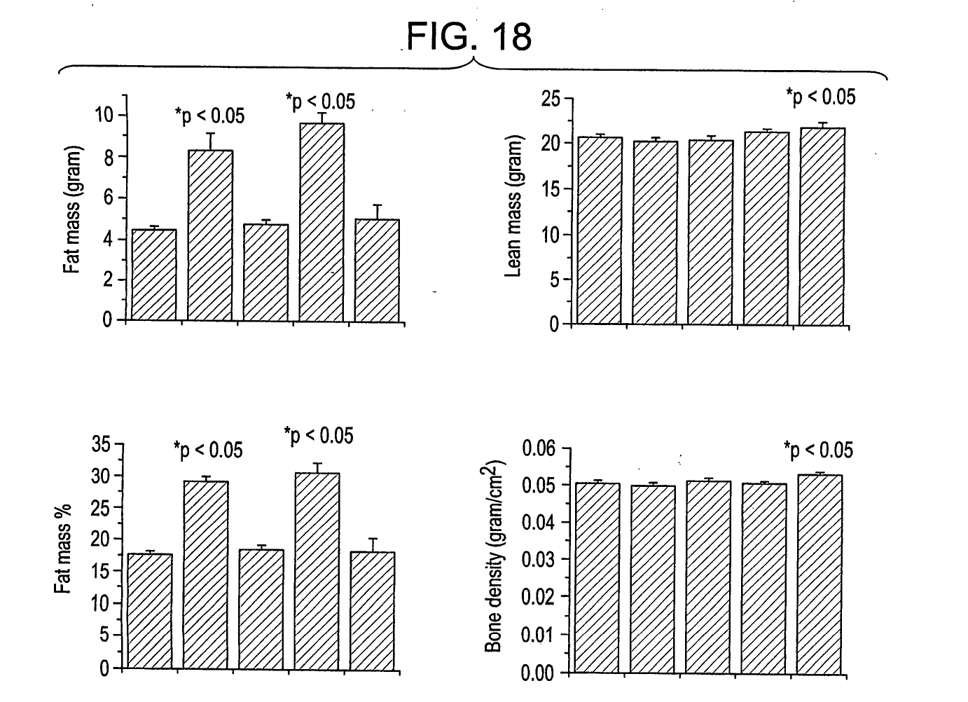

FIG. 18 demonstrates that feeding animals a diet enriched with MCT or MCT/Fish oil reduced body fat mass without affecting lean mass or bone density.

All publications and patent documents cited herein, as well as text appearing in the figures, are hereby incorporated by reference in their entirety for all purposes to the same extent as if each were so individually denoted.

References

Numeric citations can be found in the following list:
1 Metges, C. C. and Wolfram, G. (1991) Medium- and long-chain triglycerides labeled with 13C: a comparison of oxidation after oral or parenteral administration in humans. J. Nutr. 121, 31-36
2 Schwabe, A. D., Bennett, L. R. and Bowman, L. P. (1964) Octanoic acid absorption and oxidation in humans. J. Appl. Physiol. 19, 335-337
3 Pegorier, J.-P., Duee, P.-H., Herbin, C., Laulan, P.-Y., Blade, C., Peret, J. and Girard, J. (1988) Fatty acid metabolism in hepatocytes isolated from rats adapted to high-fat diets containing long- or medium-chain triglycerides. Biochem. J. 249, 801-806
4 Maragoudakis, M. E., Kalinsky, H. J. and Lennane, J. (1975) Metabolism of octanoate and its effects on glucose and palmitate utilization by isolated fat cells. Proc. Soc. Exp. Biol. Med. 148, 606-610
5 Crozier, G. L. (1988) Medium chain triglyceride feeding over the long term: the metabolic fate of [14C]octanoate and [14C]oleate in isolated rat hepatocytes. J. Nutr. 118, 297-304
6 Christensen, E., Hagve, T. A., Gronn, M. and Christophersen, B. O. (1989) Beta-oxidation of medium chain (C8-C14) fatty acids studied in isolated liver cells. Biochim. Biophys. Acta 1004, 187-195
7 Binnert, C., Pachiaudi, C., Beylot, M., Hans, D., Vandermander, J., Chantre, P., Riou, J. P. and Laville, M. (1998) Influence of human obesity on the metabolic fate of dietary long- and medium-chain triacylglycerols. Am. J. Clin. Nutr. 67, 595-601
8 Kaunitz, H., Slanetz, C. A., Johnson, R. E., Babayan, V. K. and Barsky, G. (1958) Relation of saturated, medium- and long-chain triglycerides to growth, appetite, thirst and weight maintenance requirements. J. Nutr. 64, 513-524
9 Geliebter, A., Torbay, N., Bracco, E. F., Hashim, S. A. and Van Itallie, T. B. (1983) Overfeeding with medium-chain triglyceride diet results in diminished deposition of fat. Am. J. Clin. Nutr. 37, 14
10 Hashim, S. A. and Tantibhedyangkul, P. (1987) Medium chain triglyceride in early life: effects on growth of adipose tissue. Lipids 22, 429-434
11 Chanez, M., Bois-joyeuz, B., Arnaud, M. J. and Peret, J. (1991) Metabolic effects in rats of a diet with a moderate level of medium chain triglycerides. J. Nutr. 121, 585-594
12 Wall, K. M., Schade, D. and Innis, S. M. (1994) Plasma and tissue lipids of piglets fed formula containing saturated fatty acids from medium-chain triglycerides with or without fish oil. Am. J. Clin. Nutr. 59, 1317-1324
13 Miles, J. M., Cattalini, M., Sharbrough, F. W., Wold, L. E., Wharen, R. E., Gerich, J. E. and Haymond, M. W. (1991) Metabolic and neurologic effects of an intravenous medium-chain triglyceride emulsion. J. Parenteral Enteral Nutr. 15, 37-41
14 Gordon, E. E. and Duger, J. (1975) Experimental hyperosmolar diabetic syndrome. Ketogenic response to medium-chain triglycerides. Diabetes 24, 301-306
15 Rouis, M., Dugi, K. A., Previato, L., Patterson, A. P., Brunzell, J. D., Brewer, H. B. and Santamarina-Fojo, S. (1997) Therapeutic response to medium chain triglycerides and w-3 fatty acids in a patient with the familial chylomicronemia syndrome. Arterioscler. Thromb. Vasc. Biol. 17, 1400-1406
16 Eckel, R., Hanson, A. S., Chen, A. Y., Berman, J. N., Yost, T. J. and Brass, E. P. (1992) Dietary substitution of medium-chain triglycerides improves insulin-mediated glucose metabolism in NIDDM subjects. Diabetes 41, 641-647
17 Bach, A. C., Ingenbleek, Y. and Frey, A. (1996) The usefulness of dietary medium-chain triglycerides in body weight control: fact or fancy? J. Lipid Res. 37, 708-726
18 Papamandjaris, A. A., MacDougall, D. E. and Jones, P. J. (1998) Medium chain fatty acid metabolism and energy expenditure: obesity treatment implications. Life Sci. 62, 1203-1215
19 Sigalet, D. and Martin, G. (1999) Lymphatic absorption of glucose and fatty acids as determined by direct measurement. J. Pediatr. Surg. 34, 39-43
20 Swift, L. L., Hill, J. O., Peters, J. C. and Greene, H. L. (1990) Medium-chain fatty acids: evidence for incorporation into chylomicron triglycerides in humans. Am. J. Clin. Nutr. 52, 834-836
21 Sarda, P., Lepage, G., Roy, C. and Chessex, P. (1987) Storage of medium chain triglycerides in adipose tissue of orally fed infants. Am. J. Clin. Nutr. 45, 399-406
22 Putet, G., Thelin, A. and Arnaud, M. J. (1984) Oxidation metabolism of 13C medium chain triglyceride (MCT) fed to preterm infants (PT). Pediatr. Res. 18, 344 (abstract)
23 Carnielli, V. P., Sulkers, E. J., Moretti, C., Wattimena, J. L., van Goudoever, J. B., Degenhart, H. J., Zacchello, F. and Sauer, P. J. (1994) Conversion of octanoic acid into long-chain saturated fatty acids in premature infants fed a formula containing medium-chain triglycerides. Metabolism 43, 1287-1292
24 Lassow, W. J. and Chaikoff, I. L. (1955) Carbohydrate sparing of fatty acid oxidation. Arch. Biochem. Biophys. 57, 23-28
25 Guo, W., Kirkland, J. L., Corkey, B. E. and Hamilton, J. A. (1998) A 13C nuclear magnetic resonance study of free fatty acid incorporation in acylated lipids in differentiating preadipocytes. Lipids 33, 449-454
26 Kamp, F. and Hamilton, J. A. (1993) Movement of fatty acids, fatty acid analogues, and bile acids across phospholipid bilayers. Biochemistry 32, 11074-11086
27 Guo, W., Choi, J.-K., Kirkland, J. L., Corkey, B. E. and Hamilton, J. A. (1999) Incorporation of [1-¹³C]oleate into cellular triglycerides in differentiating 3T3L1 cells. Lipids 34, 825-831
28 Labarca, C. and Paigen, K. (1980) A simple, rapid, and sensitive DNA assay procedure. Anal. Biochem. 102, 344-352
29 Kozakvak, L. P. and Jensen, J. T. (1974) Genetic and developmental control of multiple forms of glycerol-3-phosphate dehydrogenase. J. Biol. Chem. 249, 7775-7781
30 Homan, R., Grossman, J. E. and Pownall, H. J. (1991) Differential effects of eicosapentaenoic acid and oleic acid on lipid synthesis and secretion by HepG2 cells. J. Lipid Res. 32, 231-241
31 Soma, M. R., Mims, M. P., Chari, M. V., Rees, D. and Morrisett, J. D. (1992) Triglyceride metabolism in 3T3-L1 cells. An in vivo 13C NMR study. J. Biol. Chem. 267, 11168-11175
32 Lin, C. Y., Abraham, S. and Smith, S. (1976) Acyl specificity in triglyceride synthesis by lactating rat mammary gland. J. Lipid Res. 7, 647-656
33 Glenn, K. C., Shieh, J. J. and Laird, D. M. (1992) Characterization of 3T3-L1 storage lipid metabolism: effects of somatotropin and insulin on specific pathways. Endocrinology 131, 1115-1124
34 Green, H. and Kehinde, O. (1975) An established preadipose cell line and its differentiation in culture II. Factors affecting the adipose conversion. Cell 5, 19-27
35 Shillabeer, G., Forden, J. M. and Lau, D. C. (1989) Induction of preadipocyte differentiation by mature fat cells in the rat. J. Clin. Invest. 84, 381-387
36 Jump, D. B., Clarke, S. D., Thelen, A., Liimatta, M., Ren, B. and Badin, M. V. (1997) Dietary fat, genes, and human health. Adv. Exp. Med. Biol. 422, 167-176
37 Friedman, M. I. and Tordoff, M. G. (1986) Fatty acid oxidation and glucose utilization interact to control food intake in rats. Am. J. Physiol. 251, R840-R845
38 Pahl-Wostl, C. and Seelig, J. (1987) Ketogenesis in the liver followed by 13C NMR spectroscopy. Infusion of [1-13C]octanoate. Biol. Chem. 368, 305-314
39 Knittle, J. L. and Hirsch, J. (1965) Effect of chain length on rates of uptake of free fatty acids during in vitro incubations of rat adipose tissue. J. Lipid Res. 6, 565-571
40 Aas, M. (1971) Organ and subcellular distribution of fatty acid activating enzymes in the rat. Biochim. Biophys. Acta 231, 32-47
41 Brindley, D. N. (1985) Metabolism of triacylglycerol, in Biochemistry of Lipids and Membranes (Vance, D. E. and Vance, J. E., eds.), pp. 213-241, Benjamin/Cumming Publishing Company, Reading, Mass.
42 Wertheimer, H. E. (1965) Adipose Tissue (Renold, A. E. and Cahill, Jr., G. F., eds.), pp. 5-11, American Physiological Society, Washington DC
43 Deckelbaum, R. J., Hamilton, J. A., Moser, A., Bengtsson-Olivecrona, G., Butbul, E., Carpentier, Y., Gutman, A. and Olivecrona, T. (1990) Medium-chain versus long-chain triacylglycerol emulsion hydrolysis by lipoprotein lipase and hepatic lipase: implications for the mechanisms of lipase action. Biochemistry 29, 1136-1142
44 Belfrage, P., Fredrikson, G., Nilsson, N. O. and Strofors, P. (1981) Regulation of adipose-tissue lipolysis by phosphorylation of hormone-sensitive lipase. Int J. Obes. 5, 635-641
45 Amri, E.-Z., Alihaud, G. and Grialdi, P.-A. (1994) Fatty acids as signal transducing molecules: involvement in the differentiation of preadipose to adipose cells. J. Lipid Res. 35, 930-937
46 Distel, R. J., Robinson, G. S. and Spiegelman, B. M. (1992) Fatty acid regulation of gene expression: transcriptional and post-transcriptional mechanisms. J. Biol. Chem. 267, 5937-5941
47 Schoonjans, K., Watanabe, M., Suzuki, H., Mahfoudi, A., Krey, G., Wahli, W., Grimaldi, P., Staels, B., Yamamoto, T. and Auwerx, J. (1995) Induction of the acyl-Coenzyme A synthetase gene by fibrates and fatty acids is mediated by a peroxisome proliferator response element in the C promotor. J. Biol. Chem. 270, 19269-19276
48 Faergeman, N. J. and Knudsen, J. (1997) Role of long-chain fatty acyl-CoA esters in the regulation of metabolism and in cell signalling. Biochem. J. 323, 1-12
49 Prentki, M. and Corkey, B. E. (1996) Are the b-cell signaling molecules malonyl-CoA and cytosolic long-chain acyl-CoA implicated in multiple tissue defects of obesity and NIDDM? Diabetes 45, 273-283
50 Faust, I. M., Johnson, P. R., Stem, J. S. and Hirsch, J. (1978) Diet-induced adipocyte number increase in adult rats: a new model of obesity. Am. J. Physiol. 235, E279-E286
51 Hirsch, J. and Batchelor, B. (1976) Adipose tissue cellularity and human obesity. Clin. Endocrinol. Metab. 5, 299-311
52 Shillabeer, G. and Lau, D. C. W. (1994) Regulation of new fat cell formation in rats: the role of dietary fats. J. Lipid Res. 35, 592-600

Textual citations can be found in the following list.
1. Asakura, L., Lottenberg, A. M. m Neves, M. Q., Nunes, V. S., Rocha, J. C., Passarelli, M., Nakandakare, E. R., Quintao, E. C., Dietary medium chain triglyceride prevents the postprandial rise of plasma triglycerols but induces hypercholesterolemia in primary hypertriglyceridemic subjects. Am. J. Clin. nutr., 2000. 71: p. 701-705.
2. Bach, A. C., Babayan, V. K., Medium chain triglycerides: an update. Am. J. Clin. Nutr., 1982. 36.: p. 950-962.
3. Beusekom, C. V., Martini, I. A., Rutgers, H. M., Boersma, E. R., Muskiet, F. A., A carbohydrate-rich diet not only leads to incorporation of medium chain fatty acids (6:0-14:0) in milk triglycerides but also in each milk-phospholipid subclass. Am. J. Clin. Nutr., 1990. 52: p. 326-334.
4. Bitman, J., Wood, D. L., Miller, R. H., Tyrrell, H. F., Reynolds, C. K., Baxter, H. D., Comparison of milk and blood lipids in Jersey and Hosterin cows fed total mixed rations with or without cottonseed. J. Dairy Science., 1996. 79(9): p. 1596-602.
5. Blaxter, K. L., Webster, A. J. F., Animal production and foods. Problems and paranoia. Anim. Prod., 1991. 53: p.261-269.
6. Brodie, A. E., Manning, V. A., Ferguson, K. R., Jewell, D. E., Hu, C. Y., Conjugated linoleic acid inhibits differentiation of pre- and post-confluent 3T3-L1 preadipocytes but inhibits cell proliferation only in preconfluence cells. J. Nutr., 1999. 129: p.602-606.
7. Byrne, C. D., Brindle, N. P. J., Wang, T. W. M., Hales, C. N., Interaction of non-esterified fatty acid and insulin control of triacylglycerol secretion by HepG2 cells. Biochem. J., 1991. 280: p. 99-104.
8. Cherian, G., Sim, J. S., Changes in the breat milk fatty acids and plasma lipids of nursing mothers following consumption of n-3 polysaturated fatty acid enriched eggs. Nutrition., 1996. 12(1): p. 8-12.
9. Dashti, N. E., Smith, E. A., Alaupovic, P., Increased production of apolipoprotein B and its lipoproteins by oleic acid in CaCo-2 cells. J. Lipid Res., 1990. 31.: p.113-123.
10. Diraiso, F., Beylot, M., Role of human liver lipogenesis and reesterification in triglycerides secretion and in FFA resterification. Am. J. Physiol., 1998. 274: p. E321-E327.
11. Eichholzer, M., Stahelin, H., Is there a hypocholesterolemic factor in milk or milk products? Iner. J. Vit. Nutr. Res., 1993. 63: p. 159-167.

12. Franklin, S. T., Martin, K. R, Baer, R. J., Schingoethe, D. J., Hippen, A. R., Dietary marine algae (Schizochytrium sp) increases concentrations of conjugated linoleic, docosahexaenoic and transvaccenic acid in milk of daily cows. J. Nutr., 1999. 129(11): p. 2048-2052.
13. Geliebter, A., Torbay, N., Bracco, E. F., Hashim, S. A., Van Itallie, T. B., Overfeeding with medium-chain triglyceride diet results in diminished deposition of fat. Am. J. Clin. Nutr., 1983. 37: p. 1-4.

14. Gibbons, G. F., Assembly and secretion of hepatic very low density lipoprotein. Biochem. J., 1990.268: p. 1-13.
15. Guo, 1998.
16. Guo, W., 2000.
17. Han, J. R., Octanoate attenuates adipogenesis in 3T3-L1 preadipocytes. 2001.
18. Harvel, R. J., Kane, J. P., Balasses, E. O., Segel, N., Basso, L. V., Splanchnic metabolism of free fatty acids and production of triglycerides of very low density lipoproteins in normotriglyceridemic and hypertriglyceridemic humans, J. Clin. Invest., 1970.49: p. 2017-2035.
19. Hashim, S. A., Tantibhedyangkul, P., Medium chain triglycerides in early life: effects on growth of adipose tissue. Lipids., 1987. 22: p. 429-434.
20. Hill, J. O. P., J. C., Yakubu, F. Greene, H. Swift, L.; Lipid accumulation and body fat distribution is influenced by type of dietary fat fed to rats. Intl. J. Ob., 1993. 17: p. 223-236.
21. Hillgartner, F. B., Charron, T., Arachidonate and medium chain fatty acids inhibit trancription of the acetyl-CoA carboxylase gene in hepatocytes. J. Lipid Res., 1997.38: p. 2548-2557.
22. Hu, F. B., Stampfer, M. J., Manson, J. E., Ascherio, A., Colditz, G., Speizer, F. E., Hennekens, C. H., and Willett, W. C., Dietary saturation fats and their food source in relation to the risk of cornary heart disease in woman. Am. J. Clin. Nutr., 1999. 70(6): p. 1001-1008.
23. Keys, A., Atherosclerosis: a problem in newer public health. J. Mount. Sinai Hosp., 1953. 20: p. 118-139.
24. Krutchevsky, D., Tepper, S. A., Morrissey, R. B., Czarnecki, S. K., Klurfeld, D. M., Influence of whole or skim milk on cholesterol metabolism in rats. Am. J. Clin.Nutr., 1979. 32: p. 597-600.
25. Lavau, M. H., S. A., Effects of medium chain triglycerides on lipogenesis and body fat in the rat. J. Nutr., 1977. 108: p. 613-620.
26. Lewis, G. F., Uffelman, K. D., Szeto, L. W., Steiner, G., Interaction between free fatty acids and insulin in the acute control of very low density lipoprotein production in humans. J. Clin. Invest., 1995. 95: p. 158-166.
27. Lewis, G. F., Fatty acid regulation of very low density lipoprotein production. Curr. Opin. Lipidol., 1997. 8: p. 146-153.
28. Lipkin, M., Protective effects of dairy foods and their components against colon cancer: studies in preclinical models and human subjects. Proc. 25th Intern. Dairy Congr. Arahus, 1999: p. 89-100.
29. Murry, A. C., Gelaye, S., Casey, J. M., Foutz, T., Kouakou, B., Arora, D., Type of milk consumed can influence plasma concentration of fatty acids and minerals and body composition in infant and weaning pigs. J. Nutr., 1999. 129: p. 132-138.
30. Palmquist, D. L., Feeding effects of milk fat composition. Animal Science Reserach and Reviews, 2001. special circular 156: p. 1-7.
31. Potts, J. L., Coppack, S. W., Fisher, R. M., Humphreys, S. M., Gibbons, G. F., Frayn, K. N., Impaired postprandial clearance of triacylglycerol-rich lipoproteis in adipose tissue in obese subjects. Am. J. Physiol., 1995. 268: p. E588-E594.
32. Renner, E., Importance of milk and its different components for human nutrition and health. Proc. NJF/NMR-seminar No. 252., ed. S. Mantere-Alhonen, Maijala, K. 1995. 7-22.
33. Roediger, W. E. W., Nauce, S., Metabolic induction of experimental ulcerative colitis by inhibition of fatty acid oxidation. Br. J. Exp. Path., 1986. 67: p. 773-782.
34. Rossouw, J. E., Burgu, E. M., van der Uyver, P., Ferreira, J. J., The effect of skim milk, yoghurt, and full cream milk on human serum lipids. Am. J. Clin. Nutr., 1981.34.: p. 351-356.
35. Samec. S., S., J., Dulloo, A. G., Post starvation gene expression of skeletal muscle uncoupling protein 2 and uncoupling protein 3 in response to dietary fat levels and fatty acid composition, a link with insulin resistance. Diabetes., 1999. 48: p. 436-441.
36. Schneeman, B. O., Rice, R. Richter, B. D., Reduction of plasma and hepatic triglycerides with whole milk-containing diets in rats. J. Nutr., 1989. 119: p. 965-970.
37. Sidossis, L. S., Stuart, C. A., Shulman, G. I., Lopaschuk, G. D., Wolfe, R. R., Glucose plus insulin regulate fat oxidation by controling the rate of fatty acid entry into the mitochondria. J. Clin. Invest, 1996. 98: p. 2244-2250.
38. Sigalet, D., Martin, G., Lymphatic absorption of glucose and fatty acids as determined by direct measurement. J. Pediatr. Surg., 1999. 34: p. 39-43.
39. Uauy, R., Mize, C. E., Castillo-Duran, C., Fat intake during childhood: metabolic responses and effects on growth. Am. J. Clin. Nutr., 2000. 72: p. 1354S-1360S.

1. A milkfat-derived MCT-rich component comprising an appropriate ratio of milkfat-derived MCFAs to milkfat-derived LCFAs and a sufficient amount of −3 PUFAs.

2. The MCT-rich component of claim 1, wherein the ratio of milkfat-derived MCFAs to milkfat-derived LCFAs is between 5:1 to 10:1.

3. The MCT-rich component of claim 1, wherein the ratio of milkfat-derived MCFAs to milkfat-derived LCFAs selected from the group consisting of 6:1, 7:1, 7.5:1, 8:1, and 9:1.

4. The MCT-rich component of claim 1, wherein the amount of −3 PUFA is between 1% and 5%.

5. The MCT-rich component of claim 1, wherein the amount of −3 PUFA is selected from the group consisting of 1.5%, 2%, 2.5%, 3%, 3.5%, 4%, and 4.5%.

6. A dairy product for human consumption comprising the milkfat-derived MCT-rich component of claim 1.

7. A milk for human consumption comprising the milk-fat-derived MCT-rich component of claim 1.

8. A dietary supplement comprising an appropriate ratio of MCFAs to LCFAs, a sufficient amount of −3 PUFAs and a protein source.

9. The supplement of claim 8, which does not comprise a carbohydrate source.

10. The supplement of claim 9, wherein the ratio of MCFAs to LCFAs is between 5:1 to 10:1.

11. The supplement of claim 9, wherein the ratio of MCFAs to LCFAs is selected from the group consisting of 6:1, 7:1, 7.5: 1, 8:1, and 9:1.

12. The supplement of claim 9, wherein the amount of −3 PUFA is between 1% and 5%.

13. The supplement of claim 9, wherein the amount of −3 PUFA is between selected from the group consisting of 1.5%, 2%, 2.5%, 3%, 3.5%, 4%, and 4.5%.
